(19) United States
(12) Patent Application Publication
(10) Pub. No.: US 2025/0175934 A1
(43) Pub. Date: May 29, 2025

(54) POSITIONING METHOD AND APPARATUS

(71) Applicant: Huawei Technologies Co., Ltd., Shenzhen (CN)

(72) Inventors: Ting Liao, Shenzhen (CN); Zaifeng Zong, Nanjing (CN); Xiaoyun Zhou, Nanjing (CN); Xiaochun Zheng, Dongguan (CN)

(21) Appl. No.: 19/036,630

(22) Filed: Jan. 24, 2025

Related U.S. Application Data
(63) Continuation of application No. PCT/CN2023/104249, filed on Jun. 29, 2023.

(30) Foreign Application Priority Data
Jul. 27, 2022 (CN) 202210891163.8

(51) Int. Cl. H04W 64/00; H04W 24/08

(52) U.S. Cl. CPC H04W 64/00; H04W 24/08

(57) ABSTRACT

This application discloses a positioning method and an apparatus. The method includes obtaining positioning information, where the positioning information includes information about at least one tag, sending a first inventory request to a first access network device, where the first inventory request requests to inventory the at least one tag, where the first inventory request comprises the information about the at least one tag, and where the first access network device provides a service for the at least one tag, and obtaining location information of the at least one tag, or a first apparatus on which the at least one tag is disposed.

### CROSS-REFERENCE TO RELATED APPLICATIONS

This application is a continuation of International Application No. PCT/CN2023/104249, filed on Jun. 29, 2023, which claims priority to Chinese Patent Application No. 202210891163.8, filed on Jul. 27, 2022. The disclosures of the aforementioned applications are hereby incorporated by reference in their entireties.

### TECHNICAL FIELD

This application relates to the field of wireless communication, and in particular, to a positioning method and an apparatus.

### BACKGROUND

A radio frequency identification (RFID) technology is an automatic identification technology in which induction, radio waves or microwaves are used for non-contact bidirectional communication for the purpose of identification and data exchange. The RFID technology may be applied to a passive internet of things (passive IoT, PIoT), so that a tag/label in the PIoT communicates with another device after accepting external excitation.

With development of communication technologies, a wireless communication system such as a 5th generation (5G) system may be combined with the PIoT, so that a distance between a tag and a device having an excitation function is increased, and the device can centrally manage the tag. Specifically, an inventory capability (for example, a capability of reading, writing, destroying, or locking the tag) of a reader may be integrated into an access network device, so that the access network device can excite and inventory the tag. However, in a scenario in which the wireless communication system is combined with the PIoT, the tag cannot be positioned, and therefore the tag cannot be tracked and monitored.

### SUMMARY

Embodiments of this application provide a positioning method and an apparatus, to position a tag or an apparatus on which a tag is disposed.

To achieve the foregoing objectives, the following technical solutions are used in embodiments of this application.

According to a first aspect, a positioning method is provided. A communication apparatus that performs the method may be a tag management function (TMF) network element, or may be a module used for the TMF network element, for example, a chip or a chip system. The following uses an example in which the method is performed by the TMF network element for description. The method includes obtaining positioning information, where the positioning information includes information about at least one tag, sending a first inventory request to a first access network device, where the first inventory request is used to request to inventory the at least one tag, the first inventory request includes the information about the at least one tag, and the first access network device provides a service for the at least one tag, and obtaining location information of the at least one tag, or obtaining location information of a first apparatus, where the at least one tag is disposed on the first apparatus.

Based on the method provided in the first aspect, the TMF network element may obtain the positioning information, and trigger the first access network device to inventory the at least one tag, to obtain the location information of the at least one tag and position the at least one tag, or obtain the location information of the first apparatus in which the at least one tag is located and position the first apparatus. It may be understood that, in the foregoing process, the TMF network element may directly obtain the location information of the at least one tag or the location information of the first apparatus, or the TMF network element first obtains a measurement result, and obtains the location information of the at least one tag or the location information of the first apparatus based on the measurement result.

In a possible implementation, the positioning information further includes at least one of the following information about positioning precision, geographical area information of the first access network device, geographical area information of the at least one tag, information about a service type, information about a positioning periodicity, or an association identifier.

Based on the foregoing possible implementation, the positioning information may further include one or more of the information about the positioning precision, the geographical area information of the first access network device, the geographical area information of the at least one tag, the information about the service type, the information about the positioning periodicity, or the association identifier, so that a tag is positioned based on the foregoing information. For example, the TMF network element may determine, based on the information about the positioning precision, whether a location management function (LMF) network element is required to assist in positioning the at least one tag. The TMF network element may determine, based on the geographical area information of the first access network device and/or the geographical area information of the at least one tag, the first access network device configured to inventory the at least one tag. The TMF may determine, based on the information about the service type, a specific service provided for the at least one tag. The TMF network element may determine, based on the information about the positioning periodicity, an interval at which the at least one tag is positioned. The TMF network element may use the association identifier to identify a related message, so that a receiver determines that the message is related to the at least one tag.

In a possible implementation, the service type includes a single inventory, a continuous inventory, or a periodic inventory, and the association identifier identifies information related to positioning and/or the inventory of the at least one tag.

Based on the foregoing possible implementation, a service such as the single inventory, the continuous inventory, or the periodic inventory may be provided for the at least one tag. The information related to the positioning and/or the inventory of the at least one tag may be further identified by the association identifier. It may be understood that, when a single inventory service is provided for a tag, location information of the tag may be obtained, when a continuous inventory service is provided for a tag, location information of the tag may be obtained a plurality of times within a period of time, to track and monitor the tag, and when a periodic inventory service is provided for a tag, location information of the tag may be periodically obtained, to track and monitor the tag.

In a possible implementation, the at least one tag includes a first tag, and the method further includes sending a first positioning request to the LMF network element, where the first positioning request is used to request to position the first tag, and the first positioning request includes an identifier of the first tag.

Based on the foregoing possible implementation, the LMF network element may be triggered to position the first tag, to obtain location information of the first tag.

In a possible implementation, the first positioning request further includes at least one of type information of the first tag or information about a service type of the first tag.

Based on the foregoing possible implementation, the first positioning request may further include the type information of the first tag and/or the information about the service type of the first tag, to position the first tag. For example, a type of the first tag may be determined based on the type information of the first tag, and positioning is performed based on the type of the first tag in a manner suitable for the first tag. The service type of the first tag may be determined based on the information about the service type of the first tag, to provide a corresponding service for the first tag.

In a possible implementation, the sending a first positioning request to the LMF network element includes periodically sending the first positioning request to the LMF network element.

Based on the foregoing possible implementation, the first tag may be periodically positioned, to track and monitor the tag.

In a possible implementation, the at least one tag further includes a second tag, and the obtaining location information of a first apparatus includes receiving the location information of the first apparatus from the LMF network element, where the location information of the first apparatus is obtained based on the location information of the first tag and location information of the second tag.

Based on the foregoing possible implementation, the location information of the first apparatus may be determined based on the location information of the first tag and the location information of the second tag.

In a possible implementation, the method further includes sending a second positioning request to the LMF network element, where the second positioning request is used to request to position the second tag, and the second positioning request includes an identifier of the second tag.

Based on the foregoing possible implementation, the second tag may be positioned.

In a possible implementation, the at least one tag includes a first tag, and the obtaining location information of the at least one tag includes receiving a first measurement result from the first access network device, where the first measurement result is obtained by the first access network device in a process of inventorying the first tag, and the first measurement result is used to determine the location information of the first tag.

Based on the foregoing possible implementation, the first tag may be positioned based on the first measurement result obtained in the process of inventorying the first tag. In this case, in addition to a message sent in the inventory process, the first tag does not need to send a message for measurement, to reduce power consumption of the first tag.

In a possible implementation, the first measurement result includes at least one of the following: an identifier of a first cell, a first time difference, first phase information, or first angle information, and the first cell is a serving cell in which the first access network device provides a service for the first tag, the first time difference is a time difference between time at which the first access network device sends a first message to the first tag and time at which the first access network device receives a second message from the first tag, the first phase information indicates a carrier phase of a signal carrying the second message or indicates a carrier phase of a signal carrying the first message and a carrier phase of a signal carrying the second message, and the first angle information indicates an angle of arrival of the signal carrying the second message.

Based on the foregoing possible implementation, the first tag may be positioned based on the identifier of the first cell, the first time difference, the first phase information, or the first angle information.

In a possible implementation, the method further includes: sending the location information of the at least one tag to an application function network element and/or a network exposure function network element, or sending the location information of the first apparatus to an application function network element and/or a network exposure function network element.

Based on the foregoing possible implementation, the location information of the at least one tag or the location information of the first apparatus may be sent to the application function network element and/or the network exposure function network element, so that the application function network element and/or the network exposure function network element use/uses the location information of the at least one tag or the location information of the first apparatus.

In a possible implementation, the at least one tag includes a first tag, and the method further includes sending a third message to the first tag, where the third message is used to trigger the first tag to send a fourth message to the first access network device, so that the first access network device measures a signal carrying the fourth message.

Based on the foregoing possible implementation, the first tag may be triggered to send the fourth message to the first access network device, so that the first access network device performs measurement based on the signal carrying the fourth message.

In a possible implementation, the third message is a selection message, an acknowledgment message, a query message, a query message-like message, a message for triggering the first tag to send a reflection signal, a positioning message, or a sequence number request message.

Based on the foregoing possible implementation, the selection message, the acknowledgment message, the query message, the query message-like message, the message for triggering the first tag to send the reflection signal, the positioning message, or the sequence number request message may be used to trigger the first tag to send the fourth message to the first access network device, so that the first access network device performs measurement based on the signal carrying the fourth message.

In a possible implementation, the obtaining location information of the at least one tag includes receiving the location information of the first tag from the LMF network element.

Based on the foregoing possible implementation, the location information of the first tag may be obtained from the location management function network element.

In a possible implementation, any one of the at least one tag is a passive terminal or a semi-passive terminal.

Based on the foregoing possible implementations, the passive terminal or the semi-passive terminal may be positioned.

According to a second aspect, a positioning method is provided. A communication apparatus that performs the method may be an LMF network element, or may be a module used for the LMF network element, for example, a chip or a chip system. The following uses an example in which the method is performed by the LMF network element for description. The method includes receiving a first positioning request, where the first positioning request is used to request to position a first tag, and the first positioning request includes an identifier of the first tag, sending a third positioning request to a first access network device, where the third positioning request is used to request to position the first tag, the third positioning request includes the identifier of the first tag, and the first access network device provides a service for the first tag, and receiving a second measurement result from the first access network device, where the second measurement result is used to determine location information of the first tag.

Based on the method provided in the second aspect, the LMF network element may receive the first positioning request, and send the third positioning request to the first access network device, to trigger the first access network device to perform positioning measurement on the first tag to obtain the second measurement result, and send the second measurement result to the LMF network element, so that the LMF network element can position the first tag based on the second measurement result.

In a possible implementation, the method further includes sending a fourth positioning request to a second access network device, where the fourth positioning request is used to request the second access network device to position the first tag, and the fourth positioning request includes the identifier of the first tag, and receiving a third measurement result from the second access network device, where the third measurement result and the second measurement result are jointly used to determine the location information of the first tag.

Based on the foregoing possible implementation, the second access network device may also perform positioning measurement on the first tag to obtain the third measurement result, so that the LMF network element can position the first tag based on the second measurement result and the third measurement result, to obtain a more accurate positioning result.

In a possible implementation, the first positioning request further includes at least one of type information of the first tag or information about a service type of the first tag.

Based on the foregoing possible implementation, the first positioning request may further include the type information of the first tag and/or the information about the service type of the first tag, to position the first tag. For example, a type of the first tag may be determined based on the type information of the first tag, and positioning is performed based on the type of the first tag in a manner suitable for the first tag. The service type of the first tag may be determined based on the information about the service type of the first tag, to provide a corresponding service for the first tag.

In a possible implementation, the third positioning request further includes at least one of the following: information about a positioning measurement manner, the type information of the first tag, or the information about the service type of the first tag.

Based on the foregoing possible implementation, the third positioning request further includes one or more of the information about the positioning measurement manner, the type information of the first tag, or the information about the service type of the first tag, to position the first tag. For example, the positioning measurement manner may be determined based on the information about the positioning measurement manner, and positioning measurement is performed in the positioning measurement manner. The type of the first tag may be determined based on the type information of the first tag, and positioning is performed based on the type of the first tag in the manner suitable for the first tag. The service type of the first tag may be determined based on the information about the service type of the first tag, to provide the corresponding service for the first tag.

In a possible implementation, the positioning measurement manner includes angle measurement, phase measurement, signal strength measurement, multi-antenna measurement, fingerprint positioning measurement, or multi-tag assistance positioning measurement.

Based on the foregoing possible implementation, positioning measurement may be performed in a plurality of manners, to increase flexibility and diversity of positioning measurement.

In a possible implementation, the second measurement result is obtained by the first access network device by performing measurement in the positioning measurement manner.

Based on the foregoing possible implementation, the LMF network element may indicate the positioning measurement manner, so that the first access network device may perform positioning measurement in the appropriate positioning measurement manner.

In a possible implementation, the sending a second positioning request to the first access network device includes periodically sending the second positioning request to the first access network device.

Based on the foregoing possible implementation, the first tag may be periodically positioned, to track and monitor the tag.

In a possible implementation, the method further includes sending the location information of the first tag to a TMF network element.

Based on the foregoing possible implementation, the location information of the first tag may be sent to the TMF network element, so that the TMF network element sends the location information of the first tag to an application function network element.

In a possible implementation, the method further includes receiving the second positioning request, where the second positioning request is used to request to position a second tag, and the second positioning request includes an identifier of the second tag, sending a fifth positioning request to the first access network device, where the fifth request is used to request to position the second tag, the fifth positioning request includes the identifier of the second tag, and the first access network device further provides a service for the second tag, and receiving a fourth measurement result from the first access network device, where the fourth measurement result is used to determine location information of the second tag.

Based on the foregoing possible implementation, the second positioning request may be further received, the fifth positioning request may be sent to the first access network device, to trigger the first access network device to perform positioning measurement on the second tag and obtain the fourth measurement result, and the fourth measurement result is sent to the LMF network element, so that the LMF network element can position the second tag based on the fourth measurement result.

In a possible implementation, the method further includes sending location information of a first apparatus to the TMF network element, where the first tag and the second tag are disposed on the first apparatus, and the location information of the first apparatus is obtained based on the location information of the first tag and the location information of the second tag.

Based on the foregoing possible implementation, the location information of the first apparatus may be sent to the TMF network element, so that the tag management network element sends the location information of the first apparatus to the application function network element.

In a possible implementation, the location information of the first apparatus is an average value of the location information of the first tag and the location information of the second tag.

Based on the foregoing possible implementation, the location information of the first tag and the location information of the second tag may be averaged to obtain the location information of the first apparatus, so that the location information of the first apparatus is more accurate.

In a possible implementation, the method further includes receiving positioning assistance information from the first access network device, where the positioning assistance information includes at least one of location information of the first access network device, height information of the first access network device, or information about at least one positioning measurement manner supported by the first access network device.

Based on the foregoing possible implementation, the positioning assistance information may be obtained from the first access network device, to assist in positioning the first tag. For example, the tag may be positioned with reference to the location information of the first access network device, or the tag may be positioned with reference to the location information of the first access network device and the height information of the first access network device, or a to-be-used positioning measurement manner may be determined based on the positioning measurement manner supported by the first access network device.

In a possible implementation, the first tag is a passive terminal or a semi-passive terminal.

Based on the foregoing possible implementations, the passive terminal or the semi-passive terminal may be positioned.

In a possible implementation, the second tag is a passive terminal or a semi-passive terminal.

Based on the foregoing possible implementations, the passive terminal or the semi-passive terminal may be positioned.

According to a third aspect, a positioning method is provided. A communication apparatus that performs the method may be a first access network device, or may be a module used for the first access network device, for example, a chip or a chip system. The following provides descriptions by using an example in which the method is performed by the first access network device. The method includes receiving a first inventory request, where the first inventory request is used to request to inventory at least one tag, the first inventory request includes information about the at least one tag, and the at least one tag includes a first tag, sending a first message to the first tag, receiving a second message from the first tag, and sending a first measurement result, where the first measurement result is used to determine location information of the first tag.

Based on the method provided in the third aspect, the first access network device may receive the first inventory request, inventory the first tag based on the first inventory request, and obtain the first measurement result. In this way, the first access network device may position the first tag based on the first measurement result.

In a possible implementation, the method further includes receiving a third positioning request from an LMF network element, where the third positioning request is used to request to position the first tag, and the third positioning request includes an identifier of the first tag.

Based on the foregoing possible implementation, the first access network device may position the first tag based on the third positioning request.

In a possible implementation, the third positioning request further includes at least one of information about a positioning measurement manner, type information of the first tag, or information about a service type of the first tag.

Based on the foregoing possible implementation, the third positioning request further includes one or more of the information about the positioning measurement manner, the type information of the first tag, or the information about the service type of the first tag, to position the first tag. For example, the positioning measurement manner may be determined based on the information about the positioning measurement manner, and positioning measurement is performed in the positioning measurement manner. A type of the first tag may be determined based on the type information of the first tag, and positioning is performed based on the type of the first tag in a manner suitable for the first tag. The service type of the first tag may be determined based on the information about the service type of the first tag, to provide a corresponding service for the first tag.

In a possible implementation, the first measurement result is obtained by the first access network device by performing measurement in a measurement manner indicated by the information about the positioning measurement manner.

Based on the foregoing possible implementation, the first access network device may perform positioning measurement based on the positioning measurement manner indicated by the LMF network element.

In a possible implementation, the receiving a first positioning request from an LMF network element includes periodically receiving the third positioning request from the LMF network element.

Based on the foregoing possible implementation, the first access network device may periodically position the first tag, to track and monitor the tag.

In a possible implementation, the first measurement result includes at least one of an identifier of a first cell, a first time difference, first phase information, or first angle information, and the first cell is a serving cell in which the first access network device provides a service for the first tag, the first time difference is a time difference between time at which the first access network device sends the first message to the first tag and time at which the first access network device receives the second message from the first tag, the first phase information indicates a carrier phase of a signal carrying the second message or indicates a carrier phase of a signal carrying the first message and a carrier phase of a signal carrying the second message, and the first angle information indicates an angle of arrival of the signal carrying the second message.

Based on the foregoing possible implementation, the first access network device may obtain the identifier of the first cell, the first time difference, the first phase information, or the first angle information, to position the first tag.

In a possible implementation, the at least one tag further includes a second tag, and the method further includes sending a fifth message to the second tag, receiving a sixth message from the second tag, and sending a fourth measurement result, where the fourth measurement result is used to determine location information of the second tag.

Based on the foregoing possible implementation, the first access network device may further perform positioning measurement on the second tag to obtain the fourth measurement result, and send the fourth measurement result to another device, so that the another device positions the second tag based on the fourth measurement result.

In a possible implementation, the method further includes receiving a fifth positioning request from the LMF network element, where the fifth positioning request is used to request to position the second tag, and the fifth positioning request includes an identifier of the second tag.

Based on the foregoing possible implementation, the first access network device may position the second tag based on the fifth positioning request.

In a possible implementation, the fifth positioning request further includes at least one of information about a positioning measurement manner, type information of the second tag, or information about a service type of the second tag.

Based on the foregoing possible implementation, the fifth positioning request further includes one or more of the information about the positioning measurement manner, the type information of the second tag, or the information about the service type of the second tag, to position the second tag. For example, the positioning measurement manner may be determined based on the information about the positioning measurement manner, and positioning measurement is performed in the positioning measurement manner. A type of the second tag may be determined based on the type information of the second tag, and positioning is performed based on the type of the second tag in a manner suitable for the second tag. The service type of the second tag may be determined based on the information about the service type of the second tag, to provide a corresponding service for the second tag.

In a possible implementation, the fourth measurement result is obtained by the first access network device by performing measurement in the positioning measurement manner indicated by the fifth positioning request.

Based on the foregoing possible implementation, the first access network device may perform positioning measurement based on the positioning measurement manner indicated by the LMF network element.

In a possible implementation, the positioning measurement manner includes angle measurement, phase measurement, signal strength measurement, multi-antenna measurement, fingerprint positioning measurement, or multi-tag assistance positioning measurement.

Based on the foregoing possible implementation, the first access network device may perform positioning measurement in a plurality of manners, to increase flexibility and diversity of positioning measurement.

In a possible implementation, the method further includes sending positioning assistance information to the LMF network element, where the positioning assistance information includes at least one of location information of the first access network device, height information of the first access network device, or information about at least one positioning measurement manner supported by the first access network device.

Based on the foregoing possible implementation, the first access network device may send the positioning assistance information to the LMF network element, so that the LMF network element assists in positioning the first tag. For example, the LMF network element may position the tag with reference to the location information of the first access network device, or the LMF network element may position the tag with reference to the location information of the first access network device and the height information of the first access network device, or the LMF network element may determine a to-be-used positioning measurement manner based on the positioning measurement manner supported by the first access network device.

In a possible implementation, the first message is a selection message, an acknowledgment message, a query message, a query message-like message, a message for triggering the first tag to send a reflection signal, or a sequence number request message.

Based on the foregoing possible implementation, a plurality of types of messages may be used to trigger the first tag to send the second message.

In a possible implementation, the first tag is a passive terminal or a semi-passive terminal.

Based on the foregoing possible implementations, the passive terminal or the semi-passive terminal may be positioned.

In a possible implementation, the second tag is a passive terminal or a semi-passive terminal.

Based on the foregoing possible implementations, the passive terminal or the semi-passive terminal may be positioned.

According to a fourth aspect, a communication method is provided. A communication apparatus that performs the method may be a first tag, or may be a module used for the first tag, for example, a chip or a chip system. The following provides descriptions by using an example in which the method is performed by the first tag. The first tag is a passive terminal or a semi-passive terminal. The method includes receiving a first message, where the first message is used to trigger the first tag to reflect or reply to a received message, and sending a second message to a first access network device, where a signal carrying the second message is used by the first access network device to perform positioning measurement.

Based on the method provided in the fourth aspect, the first message may be used to trigger the first tag to send the second message, so that the first access network device performs positioning measurement based on the signal carrying the second message, to position the first tag.

In a possible implementation, the method further includes switching a switch in the first tag to a first location based on the first message, so that the first tag directly reflects the received message, that is, directly reflects the signal carrying the message.

Based on the foregoing possible implementation, the first tag may be in a reflection mode. In the reflection mode, the first tag may not parse the received message, but directly reflect the received signal, to reduce a communication delay and reduce power consumption of the first tag.

In a possible implementation, the first message is a selection message, an acknowledgment message, a query message, a query message-like message, a message for triggering the first tag to send a reflection signal, a positioning message, or a sequence number request message.

Based on the foregoing possible implementation, a plurality of types of messages may be used to trigger the first tag to reflect or reply to the received message. It may be understood that, when the first message is the message for triggering the first tag to send the reflection signal, after receiving the first message, the first tag switches the switch to a reflection location, for example, the first location, so that the first tag directly reflects the received signal. In this case, the second message is the reflection signal.

In a possible implementation, the second message is a reflection message for the first message, or the second message carries an identifier of the first tag, a random number, a sequence number, a check code, random number-like information, sequence number-like information, or check code-like information.

Based on the foregoing possible implementation, the first access network device may perform positioning measurement on the reflection message for the first message, or the message that carries the identifier of the first tag, the random number, the sequence number, the check code, the random number-like information, the sequence number-like information, or the check code-like information, to position the first tag. It may be understood that, when the first message is the selection message, the acknowledgment message, the query message, the query message-like message, the positioning message, or the sequence number request message, the second message is the message that carries the identifier of the first tag, the random number, the sequence number, the check code, the random number-like information, the sequence number-like information, or the check code-like information.

In a possible implementation, the receiving a first message includes receiving the first message from a core network element, or receiving the first message from the first access network device.

Based on the foregoing possible implementation, a core network device or the first access network device may trigger the first tag to reflect or reply to the received message.

In a possible implementation, the core network element is an access and mobility management function network element, an LMF network element, or a TMF network element.

Based on the foregoing possible implementation, the access and mobility management function network element, the LMF network element, or the TMF network element may all trigger the first tag to reflect or reply to the received message.

According to a fifth aspect, a communication apparatus is provided, and the communication apparatus may be configured to implement the foregoing method. The communication apparatus may be the TMF network element in the first aspect, or an apparatus including the TMF network element, or the communication apparatus may be the LMF network element in the second aspect, or an apparatus including the LMF, or the communication apparatus may be the first access network device in the third aspect, or an apparatus including the first access network device, or the communication apparatus may be the first tag in the fourth aspect, or an apparatus including the first tag. The communication apparatus includes a corresponding module, unit, or means for implementing the foregoing method. The module, unit, or means may be implemented by hardware, software, or hardware executing corresponding software. The hardware or the software includes one or more modules or units corresponding to the foregoing function.

With reference to the fifth aspect, in a possible implementation, the communication apparatus may include a transceiver module. The transceiver module may also be referred to as a transceiver unit, and is configured to implement a sending function and/or a receiving function in any one of the foregoing aspects and the possible implementations of the foregoing aspects. The transceiver module may include a transceiver circuit, a transceiver machine, a transceiver, or a communication interface.

With reference to the third aspect, in a possible implementation, the transceiver module includes a sending module and a receiving module, which are respectively configured to implement the sending function and the receiving function in any one of the foregoing aspects and the possible implementations of the foregoing aspects.

With reference to the third aspect, in a possible implementation, the communication apparatus further includes a processing module, and the processing module may be configured to implement a processing function in any one of the foregoing aspects and the possible implementations of the foregoing aspect. The processing module may be, for example, a processor.

According to a sixth aspect, a communication apparatus is provided, and includes a processor. The processor is configured to be coupled to a memory, and after reading instructions in the memory, perform the method in any one of the foregoing aspects based on the instructions. The communication apparatus may be the TMF network element in the first aspect, or an apparatus including the TMF network element, or the communication apparatus may be the LMF network element in the second aspect, or an apparatus including the LMF network element, or the communication apparatus may be the first access network device in the third aspect, or an apparatus including the first access network device, or the communication apparatus may be the first tag in the fourth aspect, or an apparatus including the first tag.

With reference to the sixth aspect, in a possible implementation, the communication apparatus further includes the memory. The memory is configured to store necessary program instructions and data.

With reference to the sixth aspect, in a possible implementation, the communication apparatus is a chip or a chip system. Optionally, when the communication apparatus is the chip system, the communication apparatus may include a chip, or may include a chip and another discrete device.

According to a seventh aspect, a communication apparatus is provided, and includes a processor and an interface circuit. The interface circuit is configured to receive a computer program or instructions, and transmit the computer program or the instructions to the processor. The processor is configured to execute the computer program or the instructions, to enable the communication apparatus to perform the method in any one of the foregoing aspects.

With reference to the seventh aspect, in a possible implementation, the communication apparatus is a chip or a chip system. Optionally, when the communication apparatus is the chip system, the communication apparatus may include a chip, or may include a chip and another discrete device.

According to an eighth aspect, a computer-readable storage medium is provided. The computer-readable storage medium stores instructions. When the instructions are run on a computer, the computer is enabled to perform the method in any one of the foregoing aspects.

According to a ninth aspect, a computer program product including instructions is provided. When the computer program product runs on a computer, the computer is enabled to perform the method in any one of the foregoing aspects.

For technical effects brought by any possible implementation in the fifth aspect to the ninth aspect, refer to technical effects brought by any one of the first aspect to the fourth aspect or different possible implementations in any one of the aspects. Details are not described herein again.

According to a tenth aspect, a communication system is provided. The communication system includes a TMF network element configured to perform the method in the first aspect, an LMF network element configured to perform the method in the second aspect, and a first access network device configured to perform the method in the third aspect.

With reference to the tenth aspect, in a possible implementation, the communication system further includes a first tag configured to perform the method in the fourth aspect.

It may be understood that the solutions in the foregoing aspects may be combined on a premise that the solutions are not contradictory.

### BRIEF DESCRIPTION OF THE DRAWINGS

FIG. 1 is a diagram of a tag according to an embodiment of this application;

FIG. 2A is a diagram 1 of an architecture of a communication system according to an embodiment of this application;

FIG. 2B is a diagram 2 of an architecture of a communication system according to an embodiment of this application;

FIG. 2C is a diagram 3 of an architecture of a communication system according to an embodiment of this application;

FIG. 2D is a diagram of a 5G architecture according to an embodiment of this application;

FIG. 3 is a diagram of a hardware structure of a communication apparatus according to an embodiment of this application;

FIG. 4 is a schematic flowchart 1 of a positioning method according to an embodiment of this application;

FIG. 5 is a schematic flowchart 2 of a positioning method according to an embodiment of this application;

FIG. 6 is a schematic flowchart 3 of a positioning method according to an embodiment of this application;

FIG. 7 is a schematic flowchart 4 of a positioning method according to an embodiment of this application;

FIG. 8 is a schematic flowchart 5 of a positioning method according to an embodiment of this application;

FIG. 9 is a schematic flowchart 6 of a positioning method according to an embodiment of this application;

FIG. 10 is a schematic flowchart of a communication method according to an embodiment of this application;

FIG. 11 is a diagram 1 of a structure of a communication apparatus according to an embodiment of this application;

FIG. 12 is a diagram 2 of a structure of a communication apparatus according to an embodiment of this application; and

FIG. 13 is a diagram 3 of a structure of a communication apparatus according to an embodiment of this application.

### DETAILED DESCRIPTION OF ILLUSTRATIVE EMBODIMENTS

Before embodiments of this application are described, related technical terms in embodiments of this application are explained and described. It may be understood that, the explanations and descriptions are intended to facilitate understanding of embodiments of this application, but should not be construed as a limitation on the protection scope claimed in embodiments of this application.

### 1. Inventory

In embodiments of this application, the inventory may also be referred to as inventory or may have another name, and is an operation performed by a reader on a tag, such as reading, writing, destroying, or locking, or an operation such as obtaining an identifier, a check code, or a sequence number of the tag, to determine the identifier of the tag.

### 2. Reader

In embodiments of this application, the reader may also be referred to as a tag reader, a reading device, a reader/writer, or the like, and is an apparatus that can obtain and process data of the tag.

In embodiments of this application, the reader may send a radio frequency signal to the tag through a built-in antenna, to query data from or write data into the tag, or enable the tag to return a reflection signal.

In embodiments of this application, the reader may be integrated into a network element in a wireless communication system, for example, integrated into an access network device, so that the access network device has an inventory capability.

### 3. Tag

In embodiments of this application, the tag may also be referred to as an electronic tag, an RFID tag, an RFID electronic tag, a radio frequency card, or the like, and can respond to a radio frequency signal sent by another device. The tag may carry an identifier. In an example, the tag is an active tag, a passive tag, a semi-passive tag, or the like. A source may mean a power supply.

In embodiments of this application, the active tag has an internal power supply module, and may actively detect a signal of the reader and actively transmit a signal at any time, to send information stored in the tag to the reader. The active tag may also be referred to as an active terminal.

In embodiments of this application, the passive tag does not have an internal power supply module, does not need additional energy supply, and may receive and send information by harvesting energy (for example, harvesting energy by using a backscattering technology). The passive tag includes but is not limited to an RFID passive tag, a Bluetooth passive tag, a passive internet of things (passive IoT) terminal, an ambient internet of things (ambient IoT) terminal, a Zigbee passive tag, or the like. The passive tag may also be referred to as a passive terminal.

In embodiments of this application, the semi-passive tag may also be referred to as a semi-active tag, a semi-passive terminal, a semi-active terminal, or the like. Although the semi-passive tag has an internal power supply module, the internal power supply module is usually not configured to send a radio frequency signal, but provides a voltage for a circuit that needs power supplying to maintain data inside the tag, or is configured to maintain working of a chip in the tag. Generally, the semi-passive tag is in a dormant state, does not work, and does not send a radio frequency signal to the outside, which is equivalent to a passive tag, and energy consumption of the internal power supply module in the semi-passive tag is very small. Therefore, power supply modules in some semi-passive tags may be valid for several years. When the semi-passive tag enters a signal range of the reader, the semi-passive tag is activated and enters a working state only after receiving excitation of the radio frequency signal sent by the reader, and energy support for information exchange between the semi-passive tag and the reader is mainly radio frequency energy provided by the reader.

In embodiments of this application, the tag may be in a normal reply mode or a reflection mode. After receiving the radio frequency signal, the tag in the normal reply mode parses and processes the signal. For example, after parsing, a string of random numbers (RN), a sequence number (SN), or an acknowledgment (ACK) message is returned. After receiving the radio frequency signal, the tag in the reflection mode may not perform parsing, but directly reflect the received radio frequency signal for reply.

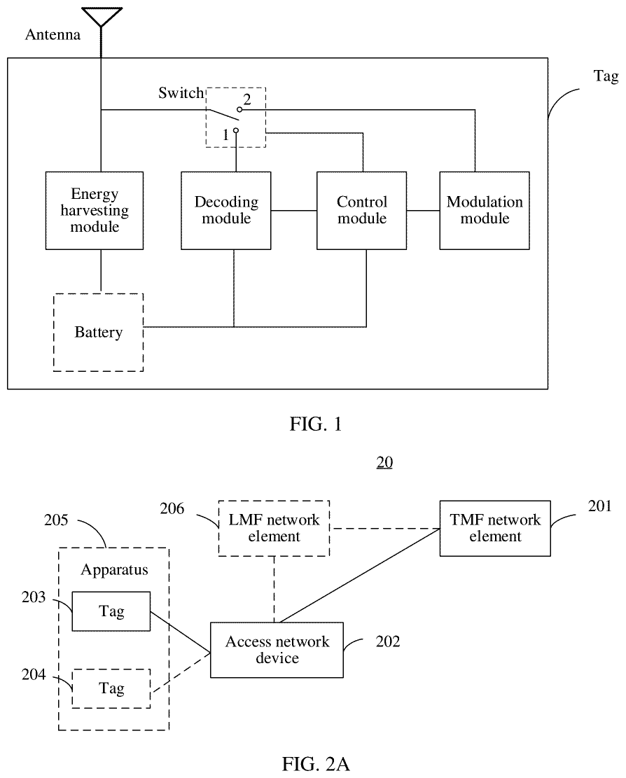

For example, FIG. 1 is a diagram of a tag. In FIG. 1, the tag includes an antenna for receiving and sending a signal, an energy harvesting module (for example, an energy harvester) and a switch that are connected to the antenna. The switch may be set to a location 1 or a location 2. When the switch is set to the location 1, the switch is connected to a decoding module (for example, an information decoder) that is configured to parse a received signal. When the switch is set to the location 2, the switch is connected to a modulation module (for example, variable impedance) that is configured to modulate a signal. The decoding module and the modulation module may be further connected to a control module (for example, a microcontroller). The control module may control the decoding module to parse a signal, and may further control the modulation module to modulate a signal and transmit a modulated signal through the antenna.

In an example, the tag shown in FIG. 1 may receive excitation of a radio frequency signal through the antenna, and enter a working state. When the switch is set to the location 1, the tag is in a normal reply mode, and the decoding module may parse the signal. When the switch is set to the location 2, the tag is in a reflection mode, and the modulation module may directly reply with a signal without parsing the received signal. Optionally, the tag shown in FIG. 1 further includes a battery, configured to obtain energy of the radio frequency signal through the energy harvesting module, and provide energy for the decoding module and the control module.

It may be understood that FIG. 1 is only the diagram of the tag. During actual application, the tag may include fewer or more modules than those shown in FIG. 1. This is not limited.

In some embodiments, the tag may alternatively be any device having a wireless transceiver function, for example, a terminal. The terminal may be deployed on land, including an indoor device, an outdoor device, a handheld device, or a vehicle-mounted device, or may be deployed on water (for example, on a ship), or may be deployed in the air (for example, on a plane, a balloon, or a satellite). The terminal may also be referred to as a terminal device. The terminal device may be user equipment (UE). The UE includes a handheld device, a vehicle-mounted device, a wearable device, or a computing device having a wireless communication function. For example, the UE may be a mobile phone (mobile phone), a tablet computer, or a computer having a wireless transceiver function. Alternatively, the terminal device may be a virtual reality (VR) terminal device, an augmented reality (AR) terminal device, a wireless terminal in industrial control, a wireless terminal in self-driving, a wireless terminal in telemedicine, a wireless terminal in a smart grid, a wireless terminal in a smart city, a wireless terminal in a smart home, or the like.

It may be understood that the foregoing is merely an example of the tag. During specific application, the tag may alternatively be in another form. For example, the tag may alternatively be an identifier, such as a bar code or a two-dimensional code, that is used to mark information by using a graph. This is not limited.

### 4. Access Network Device

In embodiments of this application, the access network device is any device having a wireless transceiver function and a reader function. The access network device includes but is not limited to an evolved NodeB (NodeB or eNB or e-NodeB) in long term evolution (LTE), a base station (gNodeB or gNB) or a transmission reception point (transmission receiving point/transmission reception point, TRP) in new radio (NR), a base station evolved after the 3rd generation partnership project (3GPP), an access node in a Wi-Fi system, a wireless relay node, a wireless backhaul node, and the like. A base station may be a macro base station, a micro base station, a pico base station, a small cell, a relay station, a balloon station, or the like. A plurality of base stations may support networks using a same technology mentioned above, or may support networks using different technologies mentioned above. The base station may include one or more co-site or non-co-site TRPs. Alternatively, the access network device may be a radio controller in a cloud radio access network (CRAN) scenario. Alternatively, the access network device may be a central unit (CU) and/or a distributed unit (DU). Alternatively, the access network device may be a server, a wearable device, a machine communication device, a vehicle-mounted device, or the like.

### 5. Location Measurement Manner

In embodiments of this application, the positioning measurement manner may include one or more of angle measurement, phase measurement, signal strength measurement, multi-antenna measurement, fingerprint positioning measurement, or multi-tag assistance positioning measurement. Details are described below.

The angle measurement may mean that an access network device measures an angle of arrival of a signal sent by a tag. Subsequently, a core network device, for example, a tag management function (TMF) network element or a location management function (LMF) network element, may determine a location of the tag with reference to angles of arrival measured by a plurality of access network devices. The signal may carry a message sent by the tag to the access network device.

The phase measurement may mean that the access network device measures a carrier phase of a signal when the signal sent by the tag is received. Subsequently, the core network device, for example, the TMF network element or the LMF network element, may determine the location of the tag with reference to carrier phases measured by the plurality of access network devices. The signal may carry the message sent by the tag to the access network device.

The signal strength measurement may mean that the access network device measures a strength of the signal received from the tag. Subsequently, the core network device, for example, the TMF network element or the LMF network element, may determine the location of the tag with reference to strengths of signals from the tag measured by the plurality of access network devices.

The multi-antenna measurement may mean that the access network device measures feature information of the signal from the tag through a plurality of antennas, for example, an angle of arrival of the signal and/or the carrier phase of the signal. Subsequently, the core network device, for example, the TMF network element or the LMF network element, may determine the location of the tag with reference to feature information measured through the plurality of antennas and deployment distances and/or deployment angles of the plurality of antennas. The signal may carry the message sent by the tag to the access network device.

The fingerprint positioning measurement may mean that the access network device measures feature information of the signal from the tag, for example, the angle of arrival of the signal, and/or the carrier phase of the signal, and/or the strength of the received signal. Subsequently, the core network device, for example, the TMF network element or the LMF network element, may determine the location of the tag based on measured feature information and a correspondence that is between feature information and location information and that is obtained in advance.

For example, the measured feature information includes an angle of arrival 1 of a signal 1 and a carrier phase 1 of the signal 1 from the tag that are measured by the access network device. The core network device may determine location information corresponding to the angle of arrival 1 and the carrier phase 1 in the correspondence that is between feature information and location information and that is obtained in advance as location information of the tag.

The multi-tag assistance measurement may mean that the access network device measures feature information of signals from a plurality of tags that are disposed on an apparatus, for example, the angle of arrival of the signal and/or the carrier phase of the signal. Subsequently, the core network device, for example, the TMF network element or the LMF network element, may determine location information of the plurality of tags with reference to measured feature information, and determine a location of the apparatus based on the location information of the plurality of tags.

The following describes implementations of embodiments of this application in detail with reference to the accompanying drawings.

A method provided in embodiments of this application may be used in various communication systems. For example, the communication system may be an LTE system, a 5G communication system, a Wi-Fi system, a 3GPP-related communication system, a future evolved communication system (for example, a 6th generation (6G) communication system), a system integrating a plurality of systems, or the like. This is not limited. 5G may also be referred to as new radio (NR).

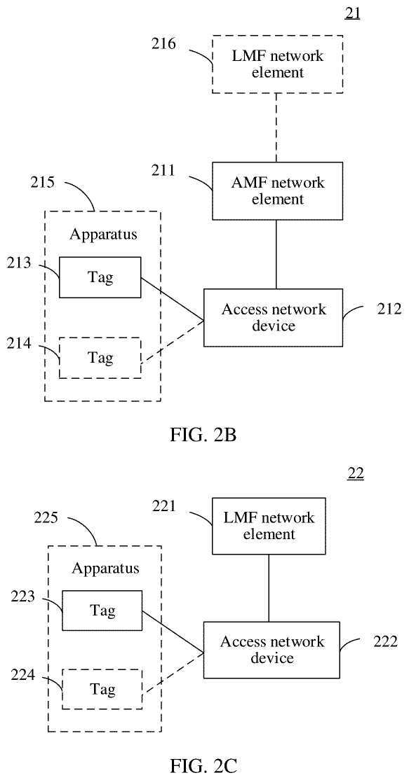

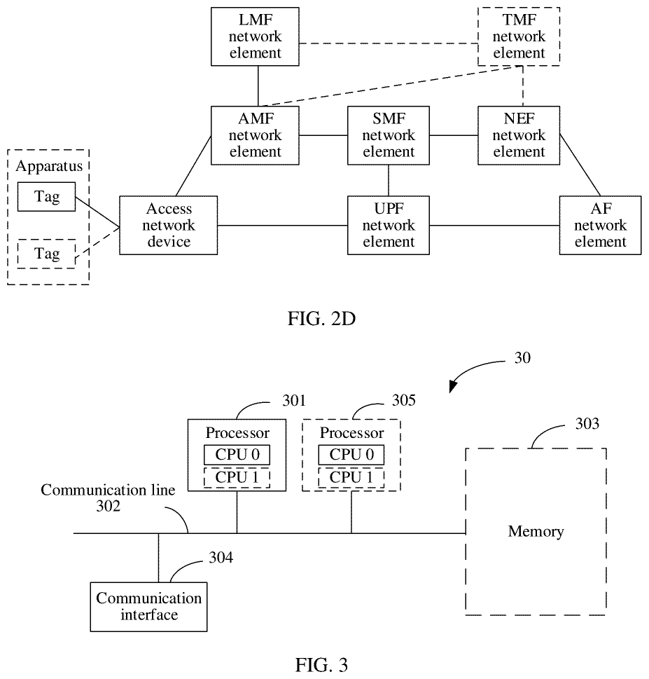

The following uses communication systems shown in FIG. 2A to FIG. 2D as an example to describe the method provided in embodiments of this application. FIG. 2A to FIG. 2D are merely diagrams, and do not constitute a limitation on a scenario to which the technical solutions provided in this application are applicable.

FIG. 2A is a diagram of an architecture of a communication system 20 according to an embodiment of this application. In FIG. 2A, the communication system 20 may include a TMF network element 201, an access network device 202 that can communicate with the TMF network element 201, and a tag 203 that can communicate with the access network device 202. For descriptions of the tag and the access network device, refer to the foregoing descriptions of the technical terms in this application.

Optionally, the communication system 20 further includes an LMF network element 206 that can communicate with the TMF network element 201 and the access network device 202, and/or a tag 204 that can communicate with the access network device 202.

Optionally, the tag 203 and the tag 204 may be disposed on one apparatus (for example, an apparatus 205).

In this embodiment of this application, an apparatus on which a tag is disposed, for example, the apparatus 205, may be any object or device, and includes but not limited to a terminal, a shelf, a package, or the like.

In this embodiment of this application, the TMF network element may have another name, or may be any existing network element. This is not limited.

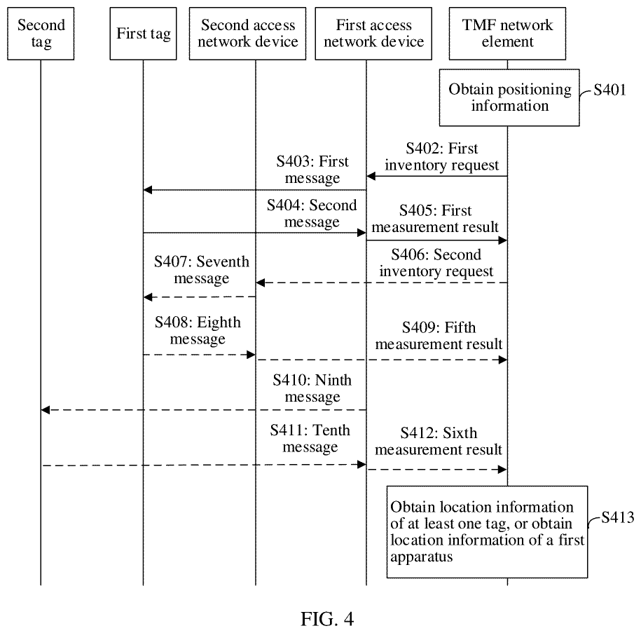

In some embodiments, the TMF network element 201 may obtain positioning information including information about at least one tag, and send a first inventory request including the information about the at least one tag to the access network device 202. The at least one tag includes the tag 203, and the first inventory request may be used to request to inventory the at least one tag. After receiving the first inventory request, the access network device 202 may inventory the tag 203, obtain a first measurement result in an inventory process, and send the first measurement result to the TMF network element 201, so that the TMF network element 201 determines location information of the tag 203 based on the first measurement result, to position the tag 203, or the TMF network element 201 determines location information of the apparatus 205 based on the first measurement result, to position the apparatus 205. The foregoing process is specifically described in the embodiment shown in FIG. 4, and details are not described herein.

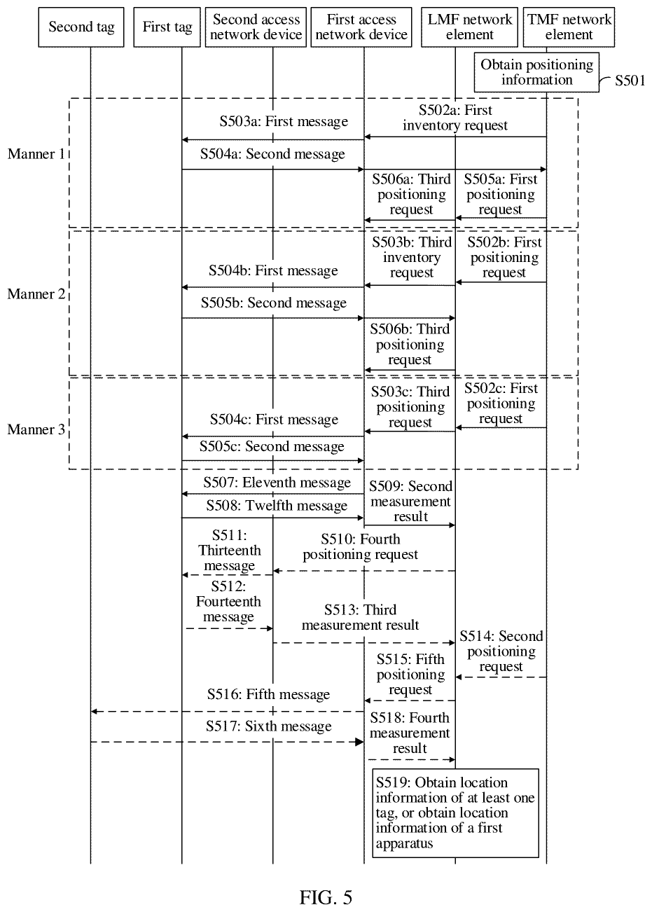

In some other embodiments, the TMF network element 201 may obtain positioning information including information about at least one tag, trigger the access network device 202 to inventory the tag 203, measure (or perform positioning measurement on) a signal carrying a message from the tag 203, and send a second measurement result obtained through measurement to the LMF network element 206. The at least one tag includes the tag 203. After receiving the second measurement result, the LMF network element 206 may determine location information of the tag 203 based on the second measurement result, to position the tag 203, or may determine location information of the apparatus 205 based on the second measurement result, to position the apparatus 205. The foregoing process is specifically described in the embodiment shown in FIG. 5, and details are not described herein.

FIG. 2B is a diagram of an architecture of a communication system 21 according to an embodiment of this application. In FIG. 2B, the communication system 21 may include an access and mobility management function (AMF) network element 211, an access network device 212 that can communicate with the AMF network element 211, and a tag 213 that can communicate with the access network device 212. For descriptions of the tag and the access network device, refer to the foregoing descriptions of the technical terms in this application. In FIG. 2B, the AMF network element 211 may function as the TMF network element in FIG. 2A.

Optionally, the communication system 21 further includes an LMF network element 216 that can communicate with the AMF network element 211, and/or a tag 214 that can communicate with the access network device 212.

Optionally, the tag 213 and the tag 214 may be disposed on one apparatus (for example, an apparatus 215). For descriptions of the apparatus 215, refer to the descriptions of the apparatus 205 in FIG. 2A.

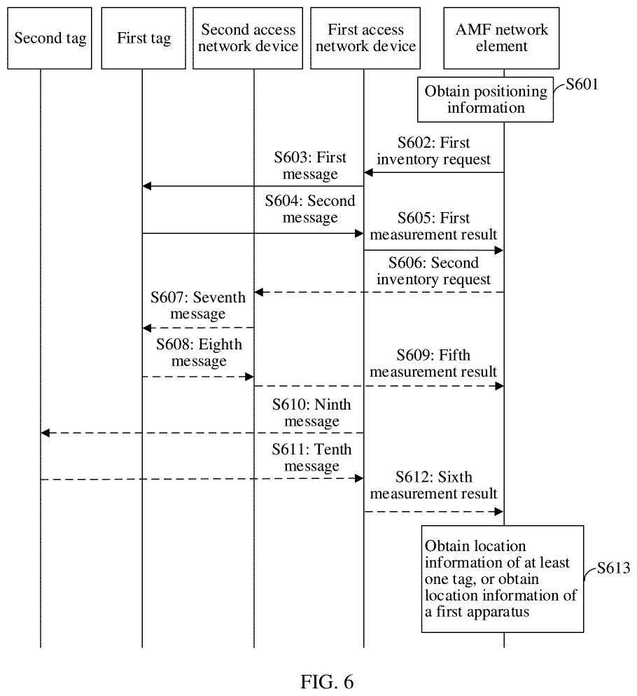

In some embodiments, the AMF network element 211 may obtain positioning information including information about at least one tag, and send a first inventory request including the information about the at least one tag to the access network device 212. The at least one tag includes the tag 213, and the first inventory request may be used to request to inventory the at least one tag. After receiving the first inventory request, the access network device 212 may inventory the tag 213, obtain a first measurement result in an inventory process, and send the first measurement result to the AMF network element 211, so that the AMF network element 211 determines location information of the tag 213 based on the first measurement result, to position the tag 213, or the AMF network element 211 determines location information of the apparatus 215 based on the first measurement result, to position the apparatus 215. The foregoing process is specifically described in the embodiment shown in FIG. 6, and details are not described herein.

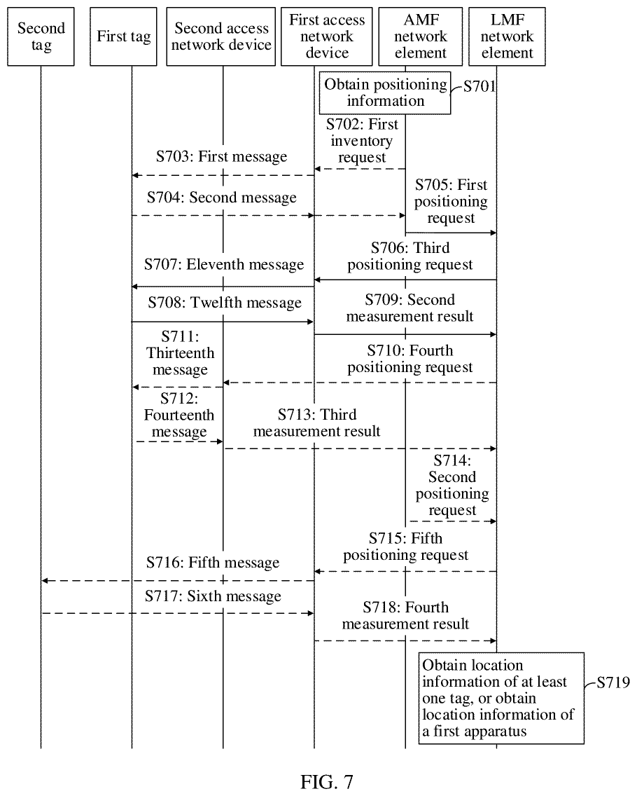

In some other embodiments, the AMF network element 211 may obtain positioning information including information about at least one tag, trigger the access network device 212 to inventory the tag 213, measure a signal carrying a message from the tag 213, and send a second measurement result obtained through measurement to the LMF network element 216. The at least one tag includes the tag 213. After receiving the second measurement result, the LMF network element 216 may determine location information of the tag 213 based on the second measurement result, to position the tag 213, or may determine location information of the apparatus 215 based on the second measurement result, to position the apparatus 215. The foregoing process is specifically described in the embodiment shown in FIG. 7, and details are not described herein.

FIG. 2C is a diagram of an architecture of a communication system 22 according to an embodiment of this application. In FIG. 2C, the communication system 22 may include an LMF network element 221, an access network device 222 that can communicate with the LMF network element 221, and a tag 223 that can communicate with the access network device 222. For descriptions of the tag and the access network device, refer to the foregoing descriptions of the technical terms in this application. In FIG. 2C, the LMF network element 221 may function as the TMF network element in FIG. 2A and have a function of positioning a tag.

Optionally, the communication system 22 further includes a tag 224 that can communicate with the access network device 222.

Optionally, the tag 223 and the tag 224 may be disposed on one apparatus (for example, an apparatus 225). For descriptions of the apparatus 225, refer to the descriptions of the apparatus 205 in FIG. 2A.

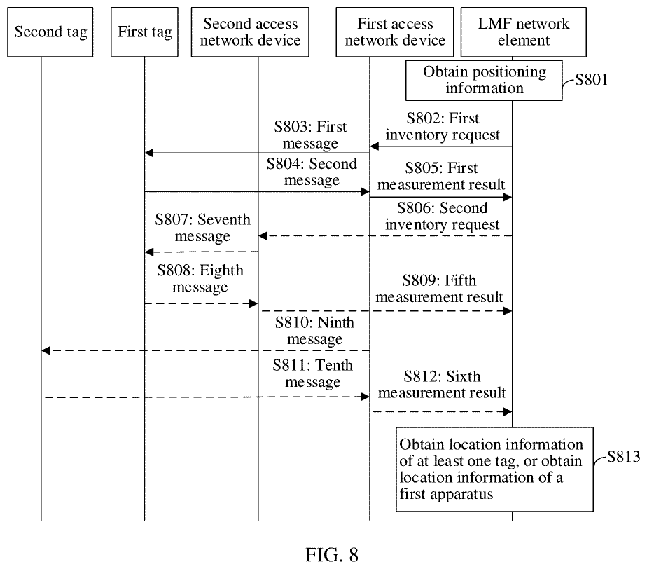

In some embodiments, the LMF network element 221 may obtain positioning information including information about at least one tag, and send a first inventory request including the information about the at least one tag to the access network device 222. The at least one tag includes the tag 223, and the first inventory request may be used to request to inventory the at least one tag. After receiving the first inventory request, the access network device 222 may inventory the tag 223, obtain a first measurement result in an inventory process, and send the first measurement result to the LMF network element 221, so that the LMF network element 221 determines location information of the tag 223 based on the first measurement result, to position the tag 223, or the LMF network element 221 determines location information of the apparatus 225 based on the first measurement result, to position the apparatus 225. The foregoing process is specifically described in the embodiment shown in FIG. 8, and details are not described herein.

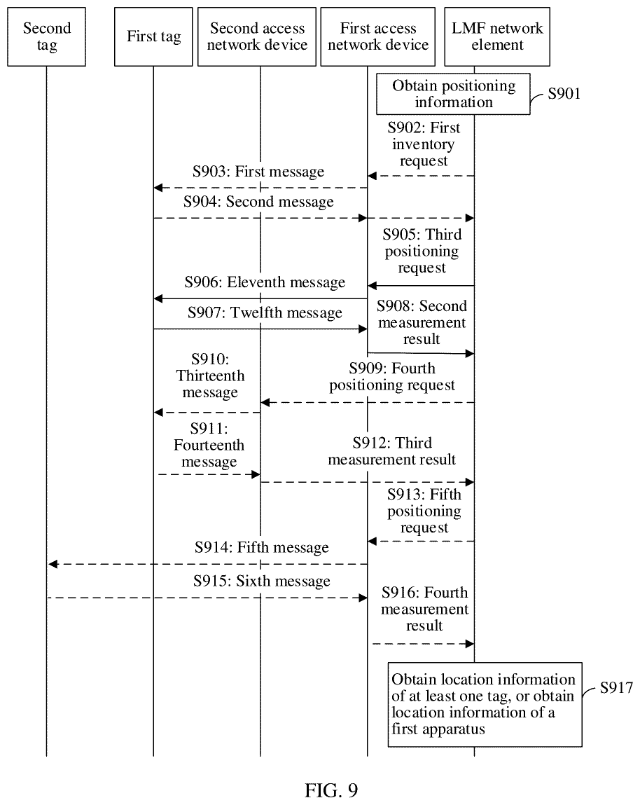

In some other embodiments, the LMF network element 221 may obtain positioning information including information about at least one tag, trigger the access network device 222 to inventory the tag 223, measure a signal carrying a message from the tag 203, and send a second measurement result obtained through measurement to the LMF network element 221. After receiving the second measurement result, the LMF network element 221 may determine location information of the tag 223 based on the second measurement result, to position the tag 223, or may determine location information of the apparatus 225 based on the second measurement result, to position the apparatus 225. The foregoing process is specifically described in the embodiment shown in FIG. 9, and details are not described herein.

It may be understood that the communication systems shown in FIG. 2A to FIG. 2C are merely used as examples, and are not intended to limit the technical solutions of this application. A person skilled in the art should understand that, in a specific implementation process, any one of the foregoing communication systems may further include another device, and quantities of TMF network elements, AMF network elements, LMF network elements, access network devices, tags, apparatuses, and the like may also be determined based on a specific requirement. This is not limited.

Optionally, any one of the foregoing communication systems is applicable to a 5G network currently being discussed, and is also applicable to a 4G network, another future network, or the like. This is not specifically limited in embodiments of this application.

For example, if any one of the foregoing communication systems is applicable to the 5G network, a network element or an entity corresponding to the access network device in the communication system may be the access network device in the 5G network shown in FIG. 2D. A network element or an entity corresponding to the tag may be the tag in the 5G network shown in FIG. 2D. A network element or an entity corresponding to the LMF network element may be the LMF network element in the 5G network shown in FIG. 2D. A network element or an entity corresponding to the TMF network element may be the TMF network element in the 5G network shown in FIG. 2D. A network element or an entity corresponding to the AMF network element may be the AMF network element in the 5G network shown in FIG. 2D. A network element or an entity corresponding to the apparatus may be the apparatus in the 5G network shown in FIG. 2D.

In addition, as shown in FIG. 2D, the 5G network may further include a session management function (SMF) network element, a user plane function (UPF) network element, a network exposure function (NEF) network element, an application function (AF) network element, and the like.

Optionally, the AMF network element, the SMF network element, the UPF network element, the NEF network element, or the AF network element may further have the following function.

The AMF network element may perform functions such as mobility management and access authentication/authorization.

The SMF network element may be configured to manage a session, allocate and manage an internet protocol (IP) address of user equipment, select an endpoint that can manage a user plane function interface and a policy control and charging function interface, perform downlink data notification, and the like.

The UPF network element may be used as an interface to a data network, and implements functions such as user plane data forwarding, session/flow level-based charging statistics collection, and bandwidth limitation, that is, packet routing and forwarding, quality of service (QoS) handling for user plane data, or the like.

The NEF network element may be configured to expose a service and a capability of a 3GPP network function to the AF network element, and may also enable the AF network element to provide information for the 3GPP network function.

The AF may represent an application function of a third party or an operator, and is an interface for a 5G mobile communication system to obtain external application data, and is mainly configured to transfer a requirement of an application side for a network side.

Optionally, each network element or device (for example, the TMF network element, the LMF network element, the AMF network element, the access network device, or the tag) in FIG. 2A to FIG. 2C in embodiments of this application may also be referred to as a communication apparatus, and may be a general-purpose device or a dedicated device. This is not specifically limited in embodiments of this application.

Optionally, related functions of each network element or device (for example, the TMF network element, the LMF network element, the AMF network element, the access network device, or the tag) in FIG. 2A to FIG. 2C in embodiments of this application may be implemented by one device, or may be jointly implemented by a plurality of devices, or may be implemented by one or more functional modules in one device. This is not specifically limited in embodiments of this application. It may be understood that the foregoing function may be a network element in a hardware device, or may be a software function running on dedicated hardware, a combination of hardware and software, or a virtualization function instantiated on a platform (for example, a cloud platform).

During specific implementation, each network element or device (for example, the TMF network element, the LMF network element, the AMF network element, the access network device, or the tag) in FIG. 2A to FIG. 2C in embodiments of this application may be of a composition structure shown in FIG. 3, or include components shown in FIG. 3. FIG. 3 is a diagram of a hardware structure of a communication apparatus applicable to embodiments of this application. The communication apparatus 30 includes at least one processor 301 and at least one communication interface 304, and is configured to implement a method provided in embodiments of this application. The communication apparatus 30 may further include a communication line 302 and a memory 303.

The processor 301 may be a general-purpose central processing unit (CPU), a microprocessor, an application-specific integrated circuit (ASIC), or one or more integrated circuits configured to control program execution of the solutions of this application.

The communication line 302 may include a path for transferring information between the foregoing components, for example, a bus.

The communication interface 304 is configured to communicate with another device or a communication network. The communication interface 304 may be any apparatus such as a transceiver, for example, may be an Ethernet interface, a radio access network (RAN) interface, a wireless local area network (WLAN) interface, a transceiver, a pin, a bus, or a transceiver circuit.

The memory 303 may be a read-only memory (ROM) or another type of static storage device capable of storing static information and instructions, a random access memory (RAM) or another type of dynamic storage device capable of storing information and instructions, or may be an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, and the like), a magnetic disk storage medium or another magnetic storage device, or any other medium capable of carrying or storing expected program code in a form of instructions or data structures and capable of being accessed by a computer, but is not limited thereto. The memory may exist independently, and is coupled to the processor 301 through the communication line 302. The memory 303 may alternatively be integrated with the processor 301. The memory provided in embodiments of this application may be usually non-volatile.

The memory 303 is configured to store computer-executable instructions for performing the solutions provided in embodiments of this application, and the processor 301 controls execution of the computer-executable instructions. The processor 301 is configured to execute the computer-executable instructions stored in the memory 303, to implement the method provided in embodiments of this application. Alternatively, optionally, in this embodiment of this application, the processor 301 may perform functions related to processing in the method provided in the following embodiments in this application, and the communication interface 304 is responsible for communication with another device or a communication network. This is not specifically limited in this embodiment of this application.

Optionally, the computer-executable instructions in this embodiment of this application may also be referred to as application program code. This is not specifically limited in this embodiment of this application.

The coupling in this embodiment of this application may be an indirect coupling or a communication connection between apparatuses, units, or modules in an electrical form, a mechanical form, or another form, and is used for information exchange between the apparatuses, the units, or the modules.

In an embodiment, the processor 301 may include one or more CPUs, for example, a CPU 0 and a CPU 1 in FIG. 3.

In an embodiment, the communication apparatus 30 may include a plurality of processors, for example, the processor 301 and a processor 305 in FIG. 3. Each of the processors may be a single-core (single-CPU) processor, or may be a multi-core (multi-CPU) processor. The processor herein may be one or more devices, circuits, and/or processing cores configured to process data (for example, computer program instructions).

It may be understood that the composition structure shown in FIG. 3 does not constitute a limitation on the communication apparatus. In addition to the components shown in FIG. 3, the communication apparatus may include more or fewer components than those shown in the figure, some components may be combined, or different component arrangements may be used.

The following describes the method provided in embodiments of this application with reference to the accompanying drawings. Network elements in the following embodiments may have the components shown in FIG. 3. Details are not described again.

It may be understood that names of messages between network elements, names of parameters in the messages, or the like in the following embodiments of this application are merely examples, and there may be other names during specific implementation. This is not specifically limited in embodiments of this application.

It may be understood that, in embodiments of this application, “/” may represent an “or” relationship between associated objects. For example, A/B may represent A or B. “And/or” may represent that three relationships exist between the associated objects. For example, A and/or B may represent the following three cases: Only A exists, both A and B exist, and only B exists. A and B may be singular or plural. In addition, a representation similar to “at least one of A, B, and C” or “at least one of A, B, or C” usually represents any one of the following: Only A exists; only B exists; only C exists; both A and B exist; both A and C exist; both B and C exist; and A, B, and C all exist. The foregoing uses three elements A, B, and C as an example to describe an optional item of the project. When there are more elements in the representation, a meaning of the representation may be obtained according to the foregoing rules.

For ease of describing the technical solutions in embodiments of this application, in embodiments of this application, words such as “first” and “second” may be used to distinguish between technical features with a same or similar function. The words such as “first” and “second” do not limit a quantity and an execution sequence, and the words such as “first” and “second” do not limit a definite difference. In embodiments of this application, the word such as “example” or “for example” represents an example, evidence, or a description. Any embodiment or design solution described as “example” or “for example” should not be explained as being more preferred or having more advantages than another embodiment or design solution. The word such as “example” or “for example” is intended to present a related concept in a specific manner for ease of understanding.

It may be understood that an “embodiment” used throughout this specification means that particular features, structures, or characteristics related to this embodiment are included in at least one embodiment of this application. Therefore, embodiments in the entire specification do not necessarily refer to a same embodiment. In addition, these particular features, structures, or characteristics may be combined in one or more embodiments in any appropriate manner. It may be understood that sequence numbers of the processes do not mean execution sequences in various embodiments of this application. The execution sequences of the processes should be determined based on functions and internal logic of the processes, and should not be construed as any limitation on implementation processes of embodiments of this application.

It may be understood that, in embodiments of this application, “when” and “if” mean that corresponding processing is performed in an objective situation, are not intended to limit time, do not require a necessary determining action during implementation, and do not mean any other limitation either.

It may be understood that in some scenarios, some optional features in embodiments of this application may be independently implemented without depending on another feature, for example, a solution on which the optional features are currently based, to resolve a corresponding technical problem and achieve corresponding effects. Alternatively, in some scenarios, the optional features may be combined with other features based on a requirement. Correspondingly, the apparatus provided in embodiments of this application may also correspondingly implement these features or functions. Details are not described herein.

It may be understood that a same step or steps or technical features that have a same function in embodiments of this application may be mutually referenced in different embodiments.

It may be understood that in embodiments of this application, the TMF network element, the access network device, the LMF network element, the AMF network element, the tag, or the like may perform some or all of steps in embodiments of this application. These steps are merely examples. In embodiments of this application, other steps or variations of various steps may be further performed. In addition, the steps may be performed in a sequence different from a sequence presented in embodiments of this application, and not all the steps in embodiments of this application need to be performed.

FIG. 4 shows a positioning method according to an embodiment of this application. The positioning method may include the following steps.

S401: A TMF network element obtains positioning information.

The TMF network element may be the TMF network element 201 in FIG. 2A.

In a possible design, the positioning information may include information about at least one tag.

The at least one tag may include any one or more tags. For example, the at least one tag includes the tag 203 and/or the tag 204 in FIG. 2A.

In this embodiment of this application, the information about the at least one tag may include an identifier of the at least one tag or a group object of the at least one tag. The group object may be mask information of the at least one tag. A to-be-positioned or to-be-inventoried identifier interval may be obtained by matching a mask in the mask information with an identifier of a tag. The identifier of the at least one tag is in the identifier interval.

In an example, if the at least one tag includes the tag 203, the positioning information includes an identifier of the tag 203, for example, an electronic product code (EPC) of the tag 203. If the at least one tag includes the tag 203 and the tag 204, the positioning information includes mask information of the tag 203 and the tag 204. An identifier interval 1 may be obtained by matching a mask in the mask information with an identifier of the tag 203 and an identifier of the tag 204. The identifier interval 1 includes the identifier of the tag 203 and the identifier of the tag 204.

In a possible implementation, the at least one tag is disposed on an apparatus, for example, a first apparatus. Alternatively, the at least one tag is disposed on different apparatuses.

For example, in FIG. 2A, the at least one tag includes the tag 203 and the tag 204, and the tag 203 and the tag 204 are disposed on the apparatus 205. In this case, the apparatus 205 is the first apparatus. Alternatively, for example, the at least one tag includes a tag 1 to a tag 3, where the tag 1 is disposed on an apparatus 1, and the tag 2 and the tag 3 are disposed on an apparatus 2.

Optionally, the positioning information further includes first information. The first information may include at least one of information about positioning precision, geographical area information of a first access network device, geographical area information of the at least one tag, information about a service type, information about a positioning periodicity, or an association identifier.

It may be understood that, different tags in the at least one tag may correspond to same first information or different first information. If different tags in the at least one tag correspond to same first information, the positioning information includes one piece of first information, or may include a plurality of pieces of first information. If different tags in the at least one tag correspond to different first information, the positioning information includes a plurality of pieces of first information.

An example in which the first information includes the information about the positioning precision and the information about the service type and the at least one tag includes the tag 1 and the tag 2 is used for description. If the positioning information includes group objects of the tag 1 and the tag 2 and first information, first information corresponding to the tag 1 is the same as first information corresponding to the tag 2, that is, information about positioning precision corresponding to the tag 1 is the same as information about positioning precision corresponding to the tag 2, and information about a service type corresponding to the tag 1 is the same as information about a service type corresponding to the tag 2. If the positioning information includes an identifier of the tag 1, first information corresponding to the tag 1, an identifier of the tag 2, and first information corresponding to the tag 2, the first information corresponding to the tag 1 and the first information corresponding to the tag 2 may be the same or may be different.

The following specifically describes content included in the first information.

In this embodiment of this application, the information about the positioning precision may indicate positioning precision. For example, the information about the positioning precision includes an identifier of the positioning precision indicated by the information about the positioning precision.

In a possible design, the positioning precision may be classified based on different requirements. For example, the positioning precision includes positioning precision at a decimeter level, positioning precision at a 1-meter level, or positioning precision at a 10-meter level. A positioning error corresponding to the positioning precision at the decimeter level is less than or equal to 1 decimeter/10 decimeters/100 decimeters. A positioning error corresponding to the positioning precision at the 1-meter level is less than or equal to 1 meter. A positioning error corresponding to the positioning precision at the 10-meter level is less than or equal to 10 meters. For another example, the positioning precision includes high-precision positioning or low-precision positioning. Specific positioning precision requirements corresponding to the high-precision positioning and the low-precision positioning may be set as required.

In this embodiment of this application, the geographical area information of the first access network device or the geographical area information of the at least one tag may indicate a geographical area of the first access network device. The first access network device is an access network device to which the at least one tag belongs, that is, the first access network device may provide a service for the at least one tag. For example, the first access network device is the access network device 202 in FIG. 2A, and may provide at least one of the following services for the tag 203 and/or the tag 204: providing energy, providing an information forwarding service, or performing signal analysis processing.

For example, the geographical area information of the first access network device may include latitude and longitude of a location of the first access network device, an area identifier of an area of the first access network device (for example, an identifier of a ** road in a ** district in a ** city in a ** province, or an identifier of a ** room in a ** unit in a ** building in a ** road in a ** district in a ** city in a ** province), a tracking area identity (tracking area identity, TAI) of the first access network device, or a tracking area list (tracking area list, TAL) of the first access network device.

In this embodiment of this application, the geographical area information of the at least one tag may include latitude and longitude of a location of the at least one tag, an area identifier of an area of the at least one tag (for example, an identifier of a ** road in a ** district in a ** city in a ** province, or an identifier of a ** room in a ** unit in a ** building in a ** road in a ** district in a ** city in a ** province), the TAI of the first access network device that provides the service for the at least one tag, or the TAL of the first access network device that provides the service for the at least one tag.

It may be understood that the TMF network element may determine the first access network device based on the geographical area information of the first access network device and/or the geographical area information of the at least one tag, and trigger the first access network device to perform inventory and positioning measurement on the at least one tag. In this embodiment of this application, positioning measurement and measurement are interchangeable.

In this embodiment of this application, the information about the service type may indicate a service type, for example, a single inventory, a continuous inventory, or a periodic inventory. The information about the service type may include an identifier of the service type indicated by the information about the service type. The single inventory may indicate that the first access network device inventories the at least one tag once. The continuous inventory may indicate that the first access network device inventories the at least one tag a plurality of times within a period of time. The periodic inventory may indicate that the first access network device periodically inventories the at least one tag.

In this embodiment of this application, the information about the positioning periodicity may indicate a periodicity for positioning the at least one tag.

In this embodiment of this application, the association identifier may identify information related to the positioning and/or the inventory of the at least one tag.

In a possible implementation, the TMF network element may obtain the positioning information from another network element, for example, an AF network element. The AF network element may be the AF network element in FIG. 2D.

For example, the TMF network element receives the positioning information from the AF network element via a NEF network element. The NEF network element may be the NEF network element in FIG. 2D. It may be understood that the AF network element may send the positioning information to the NEF network element. After receiving the positioning information, the NEF network element may directly send the positioning information to the TMF network element, that is, the AF network element transparently transmits the positioning information to the TMF network element via the NEF network element. Alternatively, after receiving the positioning information, the NEF network element converts information in the positioning information into information that can be identified by the TMF network element, and sends the converted information to the TMF network element.

In an example, the AF network element sends positioning information before conversion to the NEF network element, where the positioning information includes the information about the at least one tag and the latitude and the longitude of the location of the first access network device. The NEF network element receives the positioning information before conversion, converts the latitude and the longitude of the location of the first access network device into the TAI/TAL/an eNodeB ID of the first access network device, and sends positioning information to the TMF network element, where the positioning information includes the information about the at least one tag and the TAI/TAL/eNodeB ID of the first access network device.

In another example, the AF network element sends positioning information before conversion to the NEF network element, where the positioning information includes the information about the at least one tag and the information about the service type. The NEF network element receives the positioning information before conversion, converts the information about the service type into information about a positioning type, and sends positioning information to the TMF network element, where the positioning information includes the information about the at least one tag and the information about the positioning type. The information about the positioning type may indicate a positioning type, for example, single positioning, continuous positioning, or periodic positioning. The information about the positioning type may include an identifier of the positioning type indicated by the information about the positioning type. The single positioning may indicate that the at least one tag is positioned once. The continuous positioning may indicate that the at least one tag is positioned a plurality of times within a period of time. The periodic positioning may indicate that the at least one tag is periodically positioned.

It may be understood that the information about the positioning type may be obtained after the information about the service type is converted by the NEF network element. If the information about the service type indicates the single inventory, the information about the positioning type indicates the single positioning. If the information about the service type indicates the continuous inventory, the information about the positioning type indicates the continuous positioning. If the information about the service type indicates the periodic inventory, the information about the positioning type indicates the periodic positioning.

In a possible implementation, the TMF network element determines, based on a preset condition, whether an LMF network element is required to assist in positioning the at least one tag.

In an example, if the positioning information includes the information about the positioning precision, the TMF network element may determine, based on the information about the positioning precision, whether the LMF network element is required to assist in positioning the at least one tag. For example, if a positioning precision requirement is high (for example, the information about the positioning precision indicates the positioning precision at the decimeter level, the positioning precision at the 1-meter level, or the high-precision positioning), the TMF network element determines that the LMF network element assists in positioning the at least one tag. If a positioning precision requirement is low (for example, the information about the positioning precision indicates the positioning precision at the 10-meter level or the low-precision positioning), the TMF network element determines that the LMF network element is not required to assist in positioning the at least one tag. The LMF network element may be the LMF network element 206 in FIG. 2A.

In another example, if it is preset that the LMF network element is required to assist in positioning the at least one tag, the TMF network element determines that the LMF network element assists in positioning the at least one tag. If it is preset that the LMF network element is not required to assist in positioning the at least one tag, the TMF network element determines that the LMF network element is not required to assist in positioning the at least one tag.

It may be understood that, if the TMF network element determines that the LMF network element is not required to assist in positioning the at least one tag, the TMF network element triggers the first access network device to inventory the at least one tag, obtains a first measurement result in an inventory process, and sends the first measurement result to the TMF network element, so that the TMF network element obtains location information of the at least one tag or location information of the first apparatus based on the first measurement result. For the foregoing process, refer to the following corresponding descriptions in S402 to S405.

It may be understood that, if the TMF network element determines that the LMF network element is required to assist in positioning the at least one tag, the TMF network element triggers the first access device to perform inventory and positioning measurement on the at least one tag, and sends a measurement result to the LMF network element, so that the LMF network element positions a first tag. The foregoing process is described in the embodiment shown in FIG. 5, and details are not described herein.

S402: The TMF network element sends a first inventory request to the first access network device. Correspondingly, the first access network device receives the first inventory request from the TMF network element.

The first inventory request may be used to request to inventory the at least one tag. Optionally, the first inventory request is further used to request to measure or position the at least one tag.

In a possible design, the first inventory request may include the information about the at least one tag.

Optionally, the first inventory request further includes information about the first access network device (for example, an identifier of the first access network device) and/or the association identifier.

In a possible implementation, an alternative solution for S402 is as follows: When a quantity of the at least one tag is greater than 1, the TMF network element may indicate, through a plurality of inventory requests, the first access network device to inventory the at least one tag. For example, the TMF network element may send an inventory request for each tag, to indicate the first access network device to inventory the corresponding tag.

In a possible implementation, after receiving the first inventory request, the first access network device excites and powers on the at least one tag.

For example, if the quantity of the at least one tag is 1, the first access network device sends a command to the first tag, where the command includes an EPC of the first tag or an EPC obtained by performing full mask matching, so that the first tag is powered on and returns the EPC of the first tag. In this way, the first access network device may determine to inventory the first tag.

For another example, if the quantity of the at least one tag is greater than 1, the first access network device performs mask matching on the mask information of the at least one tag based on a mask to obtain an identifier interval, and sends a select command to perform matching on tags corresponding to identifiers in the identifier interval, so that the tags corresponding to the identifiers in the identifier interval are excited and powered on, and one tag is inventoried. It may be understood that the tags corresponding to the identifiers in the identifier interval are simultaneously excited. After these tags are excited, the first access network device sends a query message to these tags, and a tag (for example, the first tag) that responds to the query message may send a random number to the first access network device. After receiving the random number, the first access network device sends an acknowledgment (ACK) message to the first tag, where the acknowledgment message may carry the random number. The acknowledged tag (that is, the first tag) is a tag with successful random access, and is also referred to as a tag selected in this query or a random access procedure or a to-be-inventoried tag.

Optionally, after determining that the first tag needs to be inventoried, the first tag may send an identifier of the first tag to the TMF network element. Further, the first tag may send a protocol control (PC) code and/or a cyclic redundancy check (CRC) code of the first tag to the TMF network element. The identifier of the first tag and the PC or the CRC of the first tag may be sent to the TMF network element via the first access network device through a message similar to non-access stratum mobility management (NAS-MM). Correspondingly, the TMF network element receives corresponding information.

It may be understood that, after the first access network device determines that the first tag needs to be inventoried, that is, after the first access network device determines that the first tag is a unique to-be-inventoried tag, or after the first access network device obtains the random number from the first tag and determines that the unique to-be-inventoried tag is the first tag, the first tag may be inventoried by using S403 and S404.

S403: The first access network device sends a first message to the first tag. Correspondingly, the first tag receives the first message from the first access network device.

The first tag is included in the at least one tag. The first message may be used to trigger the first tag to send a second message to the first access network device.

In a possible design, the first message is a selection message, a query message, a query message-like message, an acknowledgment (ACK) message, a message for triggering the first tag to send a reflection signal, or a sequence number request (Req-RN or Request Random Number) message.

The selection message may include the identifier of the first tag or an identifier obtained by performing full mask matching, for example, the EPC of the first tag or the EPC obtained by performing full mask matching. The query message may include a query command with a Q value of 0. The query message-like message is a message whose function and/or format are/is similar to those/that of the query message. The reflection signal sent by the first tag may be a signal sent by the first tag in a reflection mode. For descriptions of the reflection mode, refer to the corresponding descriptions in the foregoing explanations and descriptions of the technical terms in embodiments of this application. The sequence number request message may be used to request a sequence number. The sequence number may be a string of random numbers, for example, an RN16 random number.

S404: The first tag sends the second message to the first access network device. Correspondingly, the first access network device receives the second message from the first tag.

In a possible design, the second message is a reflection message for the first message, or the second message carries the identifier of the first tag, a random number, a sequence number, a check code, random number-like information, sequence number-like information, or check code-like information.

It may be understood that, if the first message is a selection message, the second message includes an RN16 random number or carries the identifier of the first tag. If the first message is a query message, the second message includes an RN16 random number, a sequence number, or a check code. If the first message is a query message-like message, the second message includes RN16 random number-like information, sequence number-like information, or check code-like information. If the first message is an acknowledgment message, the second message includes the identifier of the first tag. If the first message is a message for triggering the first tag to send a reflection signal, the second message is carried in the reflection signal, that is, the second message is a reflection message for the first message. If the first message is a sequence number request message, the second message includes a sequence number.

Optionally, after receiving the second message, the first access network device sends the identifier of the first tag to the TMF network element, to indicate that the inventory on the first tag is completed.

S405: The first access network device sends the first measurement result to the TMF network element. Correspondingly, the TMF network element receives the first measurement result from the first access network device.

The first measurement result is used to determine location information of the first tag. The first measurement result may be obtained in the process (for example, S403 and S404) in which the first access network device inventories the first tag.

In a possible design, the first measurement result may include at least one of an identifier of a first cell, a first time difference, first phase information, or first angle information. For example, if the first inventory request is used to request to inventory the at least one tag, the first measurement result includes the identifier of the first cell. If the first inventory request is used to request to inventory the at least one tag and measure or position the at least one tag, the first measurement result includes at least one of the first time difference, the first phase information, or the first angle information.

The first cell is a service area in which the first access network device provides a service for the first tag. The identifier of the first cell is an identifier of the service area, for example, a cell number or a warehouse area number. The first time difference is a time difference between time at which the first access network device sends the first message to the first tag and time at which the first access network device receives the second message from the first tag. The first phase information indicates a carrier phase of a signal carrying the second message, or indicates a carrier phase of a signal carrying the first message and a carrier phase of a signal carrying the second message. The first angle information indicates an angle of arrival of the signal carrying the second message.

Optionally, in a process of positioning the first tag, in addition to the first access network device, another access network device, for example, a second access network device, may be further required to assist the first access network device in positioning the first tag. For example, if the first measurement result includes the first phase information or the first angle information, the another access network device, for example, the second access network device, is further required to assist in positioning the first tag. For example, the method shown in FIG. 4 further includes S406 to S409.

S406: The TMF network element sends a second inventory request to the second access network device. Correspondingly, the second access network device receives the second inventory request from the TMF network element.

The second access network device may be an access network device adjacent to the first access network device. The second inventory request may be used to request to inventory the first tag. Optionally, the second inventory request is further used to request to measure or position the first tag.

In a possible design, the second inventory request may include information about the first tag. Optionally, the second inventory request further includes information about the second access network device (for example, an identifier of the second access network device) and/or the association identifier.

In a possible implementation, after receiving the second inventory request, the second access network device excites and powers on the first tag. For example, the second access network device sends a command to the first tag, where the command includes the EPC of the first tag or the EPC obtained by performing full mask matching, so that the first tag is powered on and returns the EPC of the first tag. In this way, the second access network device may determine to inventory the first tag.

It may be understood that the second access network device may inventory the first tag by using S407 and S408.

S407: The second access network device sends a seventh message to the first tag. Correspondingly, the first tag receives the seventh message from the second access network device.

S408: The first tag sends an eighth message to the second access network device. Correspondingly, the second access network device receives the eighth message from the first tag.

A process of S407 and S408 is similar to the process of S403 and S404. For details, refer to the corresponding descriptions in S403 and S404. Details are not described again.

S409: The second access network device sends a fifth measurement result to the TMF network element. Correspondingly, the TMF network element receives the fifth measurement result from the second access network device.

The fifth measurement result and the first measurement result are jointly used to determine the location information of the first tag. The fifth measurement result may be obtained in the process (for example, S406 to S408) in which the second access network device inventories the first tag.

In a possible design, the fifth measurement result may include at least one of the following: a second time difference, second phase information, or second angle information.

The second time difference is a time difference between time at which the second access network device sends the seventh message to the first tag and time at which the second access network device receives the eighth message from the first tag. The second phase information indicates a carrier phase of a signal carrying the eighth message, or indicates a carrier phase of a signal carrying the seventh message and a carrier phase of a signal carrying the eighth message. The second angle information indicates an angle of arrival of the signal carrying the eighth message.

Optionally, if the quantity of the at least one tag is greater than 1, after S404, the first access network device may excite and power on a tag other than the first tag in the at least one tag. If a second tag is excited and powered on, the method shown in FIG. 4 further includes S410 to S412.

S410: The first access network device sends a ninth message to the second tag. Correspondingly, the second tag receives the ninth message from the first access network device.

S411: The second tag sends a tenth message to the first access network device. Correspondingly, the first access network device receives the tenth message from the second tag.

A process of S410 and S411 is similar to the process of S403 and S404. For details, refer to the corresponding descriptions in S403 and S404. Details are not described again.

S412: The first access network device sends a sixth measurement result to the TMF network element. Correspondingly, the TMF network element receives the sixth measurement result from the first access network device.

The sixth measurement result is used to determine location information of the second tag. The sixth measurement result may be obtained in the process (for example, S410 and S411) in which the first access network device inventories the second tag.

In a possible design, the sixth measurement result may include at least one of an identifier of a second cell, a third time difference, third phase information, or third angle information. For example, if the first inventory request is used to request to inventory the at least one tag, the sixth measurement result includes the identifier of the second cell. If the first inventory request is used to request to inventory the at least one tag and measure or position the at least one tag, the sixth measurement result includes at least one of the third time difference, the third phase information, or the third angle information.

The second cell is a service area in which the first access network device provides a service for the second tag. The identifier of the second cell is an identifier of the service area, for example, a cell number or a warehouse area number. The second cell and the first cell may be the same or may be different. The third time difference is a time difference between time at which the first access network device sends the ninth message to the second tag and time at which the first access network device receives the tenth message from the second tag. The third phase information indicates a carrier phase of a signal carrying the tenth message, or indicates a carrier phase of a signal carrying the ninth message and a carrier phase of a signal carrying the tenth message. The third angle information indicates an angle of arrival of the signal carrying the tenth message.

It may be understood that, in a process of positioning the second tag, in addition to the first access network device, another access network device may be further required to assist the first access network device in positioning the second tag. For example, if the sixth measurement result includes the third phase information or the third angle information, the another access network device may assist in positioning the second tag. For details, refer to the process in which the second access network device assists in positioning the first tag in S406 to S409. The access network device that assists the first access network device in positioning the second tag may be the same as or different from the access network device that assists the first access network device in positioning the first tag.

It may be understood that, if the at least one tag further includes a third tag, steps shown in S403 to S405 or steps shown in S403 to S409 may be used to obtain a measurement result of the third tag. Details are not described herein again.

S413: The TMF network element obtains the location information of the at least one tag, or obtains the location information of the first apparatus.

In a possible implementation, the TMF network element obtains location information of each tag based on a measurement result corresponding to each tag.

For example, the TMF network element obtains the location information of the first tag based on the first measurement result, and obtains the location information of the second tag based on the sixth measurement result. Alternatively, the TMF network element obtains the location information of the first tag based on the first measurement result and the fifth measurement result. The following uses a process in which the TMF network element obtains the location information of the first tag as an example for description. The location information of the first tag may indicate a location of the first tag.

In an example, if the first measurement result includes the identifier of the first cell, the TMF network element determines a location of the first cell as the location of the first tag. In this case, the TMF network element may obtain the location information of the first cell in advance. For example, the TMF network element pre-stores location information of the first cell, or the TMF network element obtains location information of the first cell from the first access network device or the LMF network element.

In another example, if the first measurement result includes the first time difference, the TMF network element determines a location of a cell meeting the first time difference as the location of the first tag. The cell meeting the first time difference may be understood as a cell whose message round trip time is closest to the first time difference in a plurality of cells of the first access network device. In this case, the TMF network element may obtain, in advance, message round trip time corresponding to the plurality of cells of the first access network device and location information of the plurality of cells. For example, the TMF network element pre-stores the foregoing information, or the TMF network element obtains the foregoing information from the first access network device or the LMF network element.

In another example, if the first measurement result includes the first phase information, and the fifth measurement result includes the second phase information, the TMF network element processes the first phase information and the second phase information based on a carrier phase positioning algorithm, to obtain the location information of the first tag. If the first measurement result includes the first angle information, and the fifth measurement result includes the second angle information, the TMF network element processes the first angle information and the second angle information based on an angle of arrival positioning algorithm, to obtain the location information of the first tag.

In another example, the TMF network element may determine the location information of the first tag based on the first measurement result, the fifth measurement result, and a pre-obtained correspondence between feature information and location information.

For example, the first measurement information includes the first phase information, the fifth measurement result includes the second phase information, and the pre-obtained correspondence is a correspondence between phase information and location information. The TMF network element may determine location information corresponding to the first phase information and the second phase information in the correspondence as the location information of the first tag.

For example, the first measurement result includes the first angle information, the fifth measurement result includes the second angle information, and the pre-obtained correspondence is a correspondence between angle information and location information. The TMF network element may determine location information corresponding to the first angle information and the second angle information in the correspondence as the location information of the first tag.

It may be understood that the correspondence may be pre-stored in the TMF network element, or may be obtained by the TMF network element from the first access network device or the LMF network element.

In a possible implementation, if the at least one tag is disposed on the first apparatus, the TMF network element determines the location information of the first apparatus based on the location information of the at least one tag.

In an example, if the quantity of the at least one tag is 1, the TMF network element determines the location information of the first tag as the location information of the first apparatus.

In another example, if the quantity of the at least one tag is greater than 1, the TMF network element averages the location information of the at least one tag, to obtain the location information of the first apparatus.

It may be understood that, if the information about the service type in S401 indicates the continuous inventory, after S413, the first access network device may inventory the at least one tag again. For example, in the method shown in FIG. 4, S403 to S413 may be performed again, to obtain the location information of the at least one tag or the location information of the first apparatus again, and further track and monitor the at least one tag or the first apparatus.

Similarly, if the information about the service type in S401 indicates the periodic inventory, after S413, the first access network device may periodically inventory the at least one tag. For example, in the method shown in FIG. 4, S403 to S413 may be periodically performed, to periodically obtain the location information of the at least one tag or the location information of the first apparatus, and further track and monitor the at least one tag or the first apparatus.

In a possible implementation, after S413, the TMF network element sends the location information of the at least one tag to the AF network element, or sends the location information of the first apparatus to the AF network element.

For example, the TMF network element sends the location information of the at least one tag to the AF network element via the NEF network element, or sends the location information of the first apparatus to the AF network element via the NEF network element.

It may be understood that the TMF network element may include the location information of the at least one tag in one message and send the message to the AF network element, or may include the location information of the at least one tag in a plurality of messages and send the plurality of messages to the AF network element. This is not limited.

Based on the method shown in FIG. 4, the TMF network element may obtain the positioning information, and trigger the first access network device to inventory the at least one tag, so that the first access network device obtains the first measurement result in the inventory process. In this way, the TMF network element may obtain the location information of the at least one tag based on the first measurement result, to position the at least one tag, or the TMF network element obtains, based on the first measurement result, the location information of the first apparatus in which the at least one tag is located, to position the first apparatus.

An action of the TMF network element, the first access network device, the second access network device, the first tag, or the second tag in S401 to S413 may be performed by the processor 301 in the communication apparatus 30 shown in FIG. 3 invoking the application program code stored in the memory 303. This is not limited in this embodiment of this application.

As described above, in the method shown in FIG. 4, the LMF network element does not participate in positioning of the at least one tag or positioning of the first apparatus. During specific application, the LMF network element may alternatively participate in positioning of a tag or an apparatus. For details, refer to a method shown in FIG. 5.

FIG. 5 shows another positioning method according to an embodiment of this application. The positioning method may include the following steps.

S501: A TMF network element obtains positioning information.

A process of S501 is similar to the process of S401. Therefore, refer to the corresponding descriptions in S401. Details are not described again.

Optionally, after S501, the TMF network element sends the positioning information to an LMF network element, so that the LMF network element may determine a to-be-used positioning measurement manner based on the positioning information. For descriptions of the positioning measurement manner, refer to the foregoing explanations and descriptions in the technical terms in this application. The LMF network element may be the LMF network element 206 in FIG. 2A.

Optionally, before the LMF network element determines the positioning measurement manner, a first access network device sends positioning assistance information to the LMF network element. Correspondingly, the LMF network element receives the positioning assistance information from the first access network device.

The positioning assistance information includes at least one of location information of the first access network device, height information of the first access network device, or information about at least one positioning measurement manner supported by the first access network device. The location information of the first access network device may include latitude and longitude of a location of the first access network device, an area identifier of an area of the first access network device (for example, an identifier of a ** road in a ** district in a ** city in a ** province), coordinates of the first access network device in map software, or the like. The at least one positioning measurement manner supported by the first access network device includes one or more of angle measurement, phase measurement, signal strength measurement, multi-antenna measurement, fingerprint positioning measurement, or multi-tag assistance positioning measurement.

It may be understood that, after S501, the TMF network element may trigger the first access network device to perform inventory and positioning measurement on a tag in at least one tag, so that the first access network device sends a positioning measurement result to the LMF network element, and the LMF network element positions a first tag based on the positioning measurement result. For example, the TMF network element may trigger, in at least the following three manners, the first access network device to perform inventory and positioning measurement on the tag in the at least one tag.

Manner 1: The TMF network element sends a first inventory request to the first access network device. After receiving the first inventory request, the first access network device inventories the first tag. The TMF network element further sends a first positioning request to the LMF network element, to trigger the LMF network element to send a third positioning request to the first access network device, so that the first access network device performs positioning measurement on the first tag. For details, refer to the following descriptions in S502a to S506a.

Manner 2: The TMF network element sends a first positioning request to the LMF network element, to trigger the LMF network element to send a third inventory request and a third positioning request to the first access network device, so that the first access network device performs inventory and positioning measurement on the first tag. For details, refer to the following descriptions in S502b to S506b.

Manner 3: The TMF network element sends a first positioning request to the LMF network element, to trigger the LMF network element to send a third positioning request to the first access network device, so that the first access network device performs inventory and positioning measurement on the first tag. For details, refer to the following descriptions in S502c to S505c.

First, a specific process of the manner 1 is described.

S502a: The TMF network element sends the first inventory request to the first access network device. Correspondingly, the first access network device receives the first inventory request from the TMF network element.

The first inventory request may be used to request to inventory the at least one tag.

In a possible design, the first inventory request may include information about the at least one tag. Optionally, the first inventory request further includes information about the first access network device (for example, an identifier of the first access network device) and/or an association identifier.

In a possible implementation, an alternative solution for S502a is as follows. When a quantity of the at least one tag is greater than 1, the TMF network element may indicate, through a plurality of inventory requests, the first access network device to inventory the at least one tag. For example, the TMF network element may send an inventory request for each tag, to indicate the first access network device to inventory the corresponding tag.

In a possible implementation, after receiving the first inventory request, the first access network device excites and powers on the at least one tag.

For example, if the quantity of the at least one tag is 1, the first access network device sends a command to the first tag, where the command includes an EPC of the first tag or an EPC obtained by performing full mask matching, so that the first tag is powered on and returns the EPC of the first tag. In this way, the first access network device may determine to inventory the first tag.

For another example, if the quantity of the at least one tag is greater than 1, the first access network device performs mask matching on mask information of the at least one tag based on a mask to obtain an identifier interval, and sends a select command to perform matching on tags corresponding to identifiers in the identifier interval, so that the tags corresponding to the identifiers in the identifier interval are excited and powered on, and one tag is inventoried. It may be understood that the tags corresponding to the identifiers in the identifier interval are simultaneously excited. After these tags are excited, the first access network device sends a query message to these tags, and a tag (for example, the first tag) that responds to the query message may send a random number to the first access network device. After receiving the random number, the first access network device sends an acknowledgment message to the first tag, where the acknowledgment message may carry the random number. The acknowledged tag (that is, the first tag) is a tag with successful random access, and is also referred to as a tag selected in this query or a random access procedure or a to-be-inventoried tag.

It may be understood that, after the first access network device determines that the first tag needs to be inventoried, that is, after the first access network device determines that the first tag is a unique to-be-inventoried tag, or after the first access network device obtains the random number from the first tag and determines that the unique to-be-inventoried tag is the first tag, the first tag may be inventoried by using S503a and S504a.

S503a: The first access network device sends a first message to the first tag. Correspondingly, the first tag receives the first message from the first access network device.

The first tag is included in the at least one tag. The first message may be used to trigger the first tag to send a second message to the first access network device.

In a possible design, the first message is a selection message, a query message, a query message-like message, an acknowledgment message, a message for triggering the first tag to send a reflection signal, or a sequence number request message. For descriptions of the foregoing messages, refer to the corresponding descriptions in S403.

S504a: The first tag sends the second message to the first access network device. Correspondingly, the first access network device receives the second message from the first tag.

In a possible design, the second message is a reflection message for the first message, or the second message carries the identifier of the first tag, a random number, a sequence number, a check code, random number-like information, sequence number-like information, or check code-like information.

It may be understood that, if the first message is a selection message, the second message includes an RN16 random number or carries the identifier of the first tag. If the first message is a query message, the second message includes an RN16 random number, a sequence number, or a check code. If the first message is a query message-like message, the second message includes RN16 random number-like information, sequence number-like information, or check code-like information. If the first message is an acknowledgment message, the second message includes the identifier of the first tag. If the first message is a message for triggering the first tag to send a reflection signal, the second message is carried in the reflection signal, that is, the second message is a reflection message for the first message. If the first message is a sequence number request message, the second message includes a sequence number.

It may be understood that, after receiving the second message, the first access network device sends the second message to the TMF network element. Optionally, the first tag may further send a PC and/or a CRC code of the first tag to the TMF network element. The identifier of the first tag and the PC or the CRC of the first tag may be sent to the TMF network element through a message similar to NAS-MM via the first access network device. Correspondingly, the TMF network element receives corresponding information.

S505a: The TMF network element sends the first positioning request to the LMF network element. Correspondingly, the LMF network element receives the first positioning request from the TMF network element.

The first positioning request may be used to request to position the first tag.

In a possible design, the first positioning request includes the identifier of the first tag, for example, the EPC of the first tag.

Optionally, the first positioning request further includes at least one of type information of the first tag or information about a service type of the first tag. In this way, the LMF network element may determine to position the first tag.

The type information of the first tag may indicate a type of the first tag, for example, a passive terminal, an active terminal, or a semi-passive terminal. The type information of the first tag may include an identifier of the type indicated by the type information of the first tag. The information about the service type of the first tag may indicate a service type of the first tag, for example, a single inventory, a continuous inventory, or a periodic inventory. The information about the service type of the first tag may include an identifier of the service type indicated by the information about the service type of the first tag.

S506a: The LMF network element sends the third positioning request to the first access network device. Correspondingly, the first access network device receives the third positioning request from the LMF network element.

The third positioning request may be used to request to position the first tag.

In a possible design, the third positioning request may include the identifier of the first tag, for example, the EPC of the first tag. Optionally, the third positioning request further includes at least one of information about a positioning measurement manner, the type information of the first tag, or the information about the service type of the first tag.

The information about the positioning measurement manner may indicate a positioning measurement manner. For descriptions of the positioning measurement manner, refer to the foregoing explanations and descriptions in the technical terms in this application.

The following describes a specific process of the manner 2.

S502b: The TMF network element sends the first positioning request to the LMF network element. Correspondingly, the LMF network element receives the first positioning request from the TMF network element.

A process of S502b is similar to that of S505a. For details, refer to the corresponding descriptions in S505a. Details are not described again.

S503b: The LMF network element sends the third inventory request to the first access network device. Correspondingly, the first access network device receives the third inventory request from the LMF network element.

The third inventory request may be used to request to inventory the at least one tag. The third inventory request may include the information about the at least one tag. Optionally, the third inventory request further includes the information about the first access network device (for example, the identifier of the first access network device) and/or the association identifier.

In a possible implementation, an alternative solution for S503b is as follows. When a quantity of the at least one tag is greater than 1, the LMF network element may indicate, through a plurality of inventory requests, the first access network device to inventory the at least one tag. For example, the LMF network element may send an inventory request for each tag, to indicate the first access network device to inventory the corresponding tag.

In a possible implementation, after receiving the third inventory request, the first access network device excites and powers on the at least one tag.

For example, if the quantity of the at least one tag is 1, the first access network device sends a command to the first tag, where the command includes an EPC of the first tag or an EPC obtained by performing full mask matching, so that the first tag is powered on and returns the EPC of the first tag. In this way, the first access network device may determine to inventory the first tag.

For another example, if the quantity of the at least one tag is greater than 1, the first access network device performs mask matching on mask information of the at least one tag based on a mask to obtain an identifier interval, and sends a select command to perform matching on tags corresponding to identifiers in the identifier interval, so that the tags corresponding to the identifiers in the identifier interval are excited and powered on, and one tag is inventoried. It may be understood that the tags corresponding to the identifiers in the identifier interval are simultaneously excited. After these tags are excited, the first access network device sends a query message to these tags, and a tag (for example, the first tag) that responds to the query message may send a random number to the first access network device. After receiving the random number, the first access network device sends an acknowledgment message to the first tag, where the acknowledgment message may carry the random number. The acknowledged tag (that is, the first tag) is a tag with successful random access, and is also referred to as a tag selected in this query or a random access procedure or a to-be-inventoried tag.

S504b: The first access network device sends a first message to the first tag. Correspondingly, the first tag receives the first message from the first access network device.

The first tag is included in the at least one tag. The first message may be used to trigger the first tag to send a second message to the first access network device.

In a possible design, the first message is a selection message, a query message, a query message-like message, an acknowledgment message, a message for triggering the first tag to send a reflection signal, or a sequence number request message. For descriptions of the foregoing messages, refer to the corresponding descriptions in S403.

S505b: The first tag sends the second message to the first access network device. Correspondingly, the first access network device receives the second message from the first tag.

In a possible design, the second message is a reflection message for the first message, or the second message carries the identifier of the first tag, a random number, a sequence number, a check code, random number-like information, sequence number-like information, or check code-like information.

It may be understood that, if the first message is a selection message, the second message includes an RN16 random number or carries the identifier of the first tag. If the first message is a query message, the second message includes an RN16 random number, a sequence number, or a check code. If the first message is a query message-like message, the second message includes RN16 random number-like information, sequence number-like information, or check code-like information. If the first message is an acknowledgment message, the second message includes the identifier of the first tag. If the first message is a message for triggering the first tag to send a reflection signal, the second message is carried in the reflection signal, that is, the second message is a reflection message for the first message. If the first message is a sequence number request message, the second message includes a sequence number.

It may be understood that, after receiving the second message, the first access network device sends the second message to the LMF network element. Optionally, the first tag may further send a PC and/or a CRC code of the first tag to the LMF network element. The identifier of the first tag and the PC or the CRC of the first tag may be sent to the LMF network element through a message similar to NAS-MM via the first access network device. Correspondingly, the LMF network element receives corresponding information.

S506b: The LMF network element sends the third positioning request to the first access network device. Correspondingly, the first access network device receives the third positioning request from the LMF network element.

A process of S506b is similar to that of S506a. For details, refer to the corresponding descriptions in S506a. Details are not described again.

The following describes a specific process of the manner 3.

S502c: The TMF network element sends the first positioning request to the LMF network element. Correspondingly, the LMF network element receives the first positioning request from the TMF network element.

A process of S502c is similar to that of S505a. For details, refer to the corresponding descriptions in S505a. Details are not described again.

S503c: The LMF network element sends the third positioning request to the first access network device. Correspondingly, the first access network device receives the third positioning request from the LMF network element.

The third positioning request may be used to request to inventory and position the first tag.

In a possible design, the third positioning request may include an identifier of the first tag, for example, an EPC of the first tag. Optionally, the third positioning request further includes at least one of information about a positioning measurement manner, type information of the first tag, or information about a service type of the first tag.

The information about the positioning measurement manner may indicate a positioning measurement manner. For descriptions of the positioning measurement manner, refer to the foregoing explanations and descriptions in the technical terms in this application.

S504c: The first access network device sends a first message to the first tag. Correspondingly, the first tag receives the first message from the first access network device.

The first tag is included in the at least one tag. The first message may be used to trigger the first tag to send a second message to the first access network device.

In a possible design, the first message is a selection message, a query message, a query message-like message, an acknowledgment message, a message for triggering the first tag to send a reflection signal, or a sequence number request message. For descriptions of the foregoing messages, refer to the corresponding descriptions in S403.

S505c: The first tag sends the second message to the first access network device. Correspondingly, the first access network device receives the second message from the first tag.

In a possible design, the second message is a reflection message for the first message, or the second message carries the identifier of the first tag, a random number, a sequence number, a check code, random number-like information, sequence number-like information, or check code-like information.

It may be understood that, if the first message is a selection message, the second message includes an RN16 random number or carries the identifier of the first tag. If the first message is a query message, the second message includes an RN16 random number, a sequence number, or a check code. If the first message is a query message-like message, the second message includes RN16 random number-like information, sequence number-like information, or check code-like information. If the first message is an acknowledgment message, the second message includes the identifier of the first tag. If the first message is a message for triggering the first tag to send a reflection signal, the second message is carried in the reflection signal, that is, the second message is a reflection message for the first message. If the first message is a sequence number request message, the second message includes a sequence number.

It may be understood that S504c and S505c are optional steps. When S504c and S505c are included, the first tag may be inventoried by using S504c and S505c, and positioning measurement may be performed on the first tag by using S507 and S508. When S504c and S505c are not included, inventory and positioning measurement may be performed on the first tag by using S507 and S508.

It may be understood that, after S506a, S506b, or S505c, the first access network device may perform positioning measurement on the first tag, and send a positioning measurement result to the LMF network element. For details, refer to the following corresponding descriptions in S507 to S509.

S507: The first access network device sends an eleventh message to the first tag. Correspondingly, the first tag receives the eleventh message from the first access network device.

In a possible design, the eleventh message is a selection message, an acknowledgment message, a query message, a query message-like message, a message for triggering the first tag to send a reflection signal, or a sequence number request message.

S508: The first tag sends a twelfth message to the first access network device. Correspondingly, the first access network device receives the twelfth message from the first tag.

In a possible design, the twelfth message is a reflection message for the first message, or the twelfth message carries the identifier of the first tag, a random number, a sequence number, a check code, random number-like information, sequence number-like information, or check code-like information.

It may be understood that if the eleventh message is a selection message, the twelfth message includes an RN16 random number or carries the identifier of the first tag. If the eleventh message is an acknowledgment message, the twelfth message includes the identifier of the first tag. If the eleventh message is a query message, the twelfth message includes an RN16 random number, a sequence number, or a check code. If the eleventh message is a query message-like message, the twelfth message includes RN16 random number-like information, sequence number-like information, or check code-like information. If the eleventh message is a message for triggering the first tag to send a reflection signal, the twelfth message is carried in the reflection signal, that is, the twelfth message is a reflection message for the eleventh message. If the eleventh message is a sequence number request message, the twelfth message includes a sequence number.

S509: The first access network device sends a second measurement result to the LMF network element. Correspondingly, the LMF network element receives the second measurement result from the first access network device.

The second measurement result may be used to determine location information of the first tag. The second measurement result is obtained by the first access network device by performing measurement in the positioning measurement manner indicated by the third positioning request.

For example, if the third positioning request indicates angle measurement, the first access network device measures an angle of arrival of a signal carrying the twelfth message, and the second measurement result includes the angle of arrival of the signal carrying the twelfth message.

For example, if the third positioning request indicates phase measurement, the first access network device measures a carrier phase of a signal carrying the twelfth message, and the second measurement result includes the carrier phase of the signal carrying the twelfth message.

For example, if the third positioning request indicates signal strength measurement, the first access network device measures a signal strength of a signal carrying the twelfth message, and the second measurement result includes the signal strength of the signal carrying the twelfth message.

For example, if the third positioning request indicates multi-antenna measurement, the first access network device measures feature information of the twelfth message through a plurality of antennas, for example, an angle of arrival of a signal carrying the twelfth message and/or a carrier phase of the signal carrying the twelfth message, and the second measurement result includes the angle of arrival of the signal carrying the twelfth message measured through the plurality of antennas and/or the carrier phase of the signal carrying the twelfth message measured through the plurality of antennas.

For example, if the third positioning request indicates fingerprint positioning measurement or multi-tag assistance positioning measurement, the first access network device measures feature information of the twelfth message, for example, an angle of arrival of a signal carrying the twelfth message, and/or a carrier phase of the signal carrying the twelfth message, and/or a received signal strength of the signal carrying the twelfth message, and the second measurement result includes the angle of arrival of the signal carrying the twelfth message, and/or the carrier phase of the signal carrying the twelfth message, and/or the received signal strength of the signal carrying the twelfth message.

Optionally, in a process of positioning the first tag, in addition to the first access network device, another access network device, for example, a second access network device, may be further required to assist the first access network device in positioning the first tag. The second access network device may be determined by the LMF network element, and is an access network device adjacent to the first access network device. For example, the method shown in FIG. 5 further includes S510 to S513.

S510: The LMF network element sends a fourth positioning request to the second access network device. Correspondingly, the second access network device receives the fourth positioning request from the LMF network element.

The fourth positioning request may be used to request to position the first tag.

In a possible design, the fourth positioning request may include the identifier of the first tag, for example, the EPC of the first tag. Optionally, the fourth positioning request further includes at least one of information about a positioning measurement manner, the type information of the first tag, or the information about the service type of the first tag.

S511: The second access network device sends a thirteenth message to the first tag. Correspondingly, the first tag receives the thirteenth message from the second access network device.

S512: The first tag sends a fourteenth message to the second access network device. Correspondingly, the second access network device receives the fourteenth message from the first tag.

A process of S511 and S512 is similar to the process of S507 and S508. Therefore, refer to the corresponding descriptions in S507 and S508. Details are not described again.

S513: The second access network device sends a third measurement result to the LMF network element. Correspondingly, the LMF network element receives the third measurement result from the second access network device.

The third measurement result and the second measurement result may be jointly used to determine the location information of the first tag. The third measurement result is obtained by the second access network device by performing measurement in the positioning measurement manner indicated by the fourth positioning request. For details, refer to the descriptions of the second measurement result in S509. Details are not described herein again.

Optionally, if the quantity of the at least one tag is greater than 1, after S508, the first access network device may excite and power on a tag other than the first tag in the at least one tag. If a second tag is excited and powered on, the method shown in FIG. 5 further includes S514 to S518.

S514: The TMF network element sends a second positioning request to the LMF network element. Correspondingly, the LMF network element receives the second positioning request from the TMF network element.

The second positioning request may be used to request to position the second tag.

In a possible design, the second positioning request includes an identifier of the second tag, for example, an EPC of the second tag. Optionally, the second positioning request further includes at least one of type information of the second tag or information about a service type of the second tag. In this way, the LMF network element may determine to position the second tag.

The type information of the second tag may indicate a type of the second tag, for example, a passive terminal, an active terminal, or a semi-passive terminal. The type information of the second tag may include an identifier of the type indicated by the type information of the second tag. The information about the service type of the second tag may indicate a service type of the second tag, for example, a single inventory, a continuous inventory, or a periodic inventory. The information about the service type of the second tag may include an identifier of the service type indicated by the information about the service type of the second tag.

S515: The LMF network element sends a fifth positioning request to the first access network device. Correspondingly, the first access network device receives the fifth positioning request from the LMF network element.

The fifth positioning request may be used to request to position the second tag.

In a possible design, the fifth positioning request may include the identifier of the second tag, for example, the EPC of the second tag. Optionally, the fifth positioning request further includes at least one of information about a positioning measurement manner, the type information of the second tag, or the information about the service type of the second tag.

The information about the positioning measurement manner may indicate a positioning measurement manner. For descriptions of the positioning measurement manner, refer to the foregoing explanations and descriptions in the technical terms in this application.

S516: The first access network device sends a fifth message to the second tag. Correspondingly, the second tag receives the fifth message from the first access network device.

In a possible design, the fifth message is a selection message, an acknowledgment message, a query message, a query message-like message, a message for triggering the second tag to send a reflection signal, or a sequence number request message.

S517: The second tag sends a sixth message to the first access network device. Correspondingly, the first access network device receives the sixth message from the second tag.

In a possible design, the sixth message is a reflection message for the fifth message, or the sixth message carries the identifier of the first tag, a random number, a sequence number, a check code, random number-like information, sequence number-like information, or check code-like information.

It may be understood that, if the fifth message is a selection message, the sixth message includes an RN16 random number or carries the identifier of the first tag. If the fifth message is an acknowledgment message, the sixth message includes the identifier of the first tag. If the fifth message is a query message, the sixth message includes an RN16 random number, a sequence number, or a check code. If the fifth message is a query message-like message, the sixth message includes RN16 random number-like information, sequence number-like information, or check code-like information. If the fifth message is a message for triggering the second tag to send a reflection signal, the sixth message is carried in the reflection signal, that is, the sixth message is a reflection message for the fifth message. If the fifth message is a sequence number request message, the sixth message includes a sequence number.

S518: The first access network device sends a fourth measurement result to the LMF network element. Correspondingly, the LMF network element receives the fourth measurement result from the first access network device.

The fourth measurement result may be used to determine location information of the second tag. The fourth measurement result is obtained by the first access network device by performing measurement in the positioning measurement manner indicated by the fifth positioning request. For details, refer to the descriptions of the second measurement result in S509. Details are not described herein again.

It may be understood that, in a process of positioning the second tag, in addition to the first access network device, another access network device may be further required to assist the first access network device in positioning the second tag. For details, refer to the process in which the second access network device assists in positioning the first tag in S510 to S513. The access network device that assists the first access network device in positioning the second tag may be the same as or different from the access network device that assists the first access network device in positioning the first tag.

It may be understood that, if the at least one tag further includes a third tag, steps shown in S514 to S518 may be used to obtain a measurement result of the third tag. Details are not described herein again.

S519: The LMF network element obtains location information of the at least one tag, or obtains location information of a first apparatus.

In a possible implementation, the LMF network element obtains location information of each tag based on a measurement result corresponding to each tag. For example, the LMF network element obtains the location information of the first tag based on the second measurement result, and obtains the location information of the second tag based on the fourth measurement result. Alternatively, the LMF network element obtains the location information of the first tag based on the second measurement result and the third measurement result. The following uses a process in which the LMF network element obtains the location information of the first tag as an example for description. The location information of the first tag may indicate a location of the first tag.

In an example, if the third positioning request indicates multi-antenna measurement, and the second measurement result includes feature information measured through a plurality of antennas (for example, an angle of arrival and/or a carrier phase measured through each of the plurality of antennas), the LMF network element determines the location information of the first tag based on the feature information measured through the plurality of antennas and deployment distances and/or deployment angles of the plurality of antennas. It may be understood that the deployment distances and/or the deployment angles of the plurality of antennas may be pre-stored in the LMF network element, or may be obtained by the LMF network element from the first access network device.

In another example, if both the third positioning request and the fourth positioning request indicate phase measurement, the second measurement result includes phase information measured by the first access network device, and the third measurement result includes phase information measured by the second access network device, the LMF network element processes, based on a carrier phase positioning algorithm, the phase information measured by the first access network device and the phase information measured by the second access network device, to obtain the location information of the first tag.

In another example, if both the third positioning request and the fourth positioning request indicate angle measurement, the second measurement result includes angle information measured by the first access network device, and the third measurement result includes angle information measured by the second access network device, the LMF network element processes, based on an angle of arrival positioning algorithm, the angle information measured by the first access network device and the angle information measured by the second access network device, to obtain the location information of the first tag.

In another example, the LMF network element may determine the location information of the first tag based on the second measurement result, the third measurement result, and a pre-obtained correspondence between feature information and location information.

For example, the second measurement information includes phase information measured by the first access network device, the third measurement result includes phase information measured by the second access network device, and the pre-obtained correspondence is a correspondence between phase information and location information. The LMF network element may determine, in the correspondence, location information corresponding to the phase information measured by the first access network device and the phase information measured by the second access network device as the location information of the first tag.

It may be understood that the correspondence may be pre-stored in the LMF network element, or may be obtained by the LMF network element from the first access network device.

In a possible implementation, if the at least one tag is disposed on the first apparatus, the LMF network element determines the location information of the first apparatus based on the location information of the at least one tag.

In an example, if the quantity of the at least one tag is 1, the LMF network element determines the location information of the first tag as the location information of the first apparatus.

In another example, if the quantity of the at least one tag is greater than 1, the LMF network element averages the location information of the at least one tag, to obtain the location information of the first apparatus.

It may be understood that, if the information about the service type in S501 indicates the continuous inventory, after S519, the first access network device may inventory the at least one tag again. For example, in the method shown in FIG. 5, S503a to S506a and S507 to S519 may be performed again, to obtain the location information of the at least one tag or the location information of the first apparatus again, and further track and monitor the at least one tag or the first apparatus.

Similarly, if the information about the service type in S501 indicates the periodic inventory, after S519, the first access network device may periodically inventory the at least one tag. For example, in the method shown in FIG. 5, S503a to S506a and S507 to S519 may be periodically performed. Alternatively, after S519, the TMF network element may periodically trigger the LMF network element to position the at least one tag. For example, in the method shown in FIG. 5, S505a, S506a and S507 to S519 may be periodically performed. Alternatively, after S519, the LMF network element may periodically trigger an access network device (for example, the first access network device, or the first access network device and the second access network device) to obtain a measurement result corresponding to the at least one tag. For example, in the method shown in FIG. 5, S506a and S507 to S519 may be periodically performed. In this way, the location information of the at least one tag or the location information of the first apparatus may be periodically obtained, to track and monitor the at least one tag or the first apparatus.

In a possible implementation, after S519, the LMF network element sends the location information of the at least one tag to an AF network element, or sends the location information of the first apparatus to the AF network element.

For example, the LMF network element sends the location information of the at least one tag to the AF network element via the TMF network element, or sends the location information of the first apparatus to the AF network element via the TMF network element.

It may be understood that the LMF network element may include the location information of the at least one tag in one message and send the message to the AF network element, or may include the location information of the at least one tag in a plurality of messages and send the plurality of messages to the AF network element. This is not limited.

It may be understood that S519 may not be performed in this embodiment of this application. In this case, the LMF network element may send a received measurement result to the TMF network element, so that the TMF network element obtains the location information of the at least one tag or the location information of the first apparatus based on the received measurement result. Subsequently, the TMF network element may further send the location information of the at least one tag or the location information of the first apparatus to the AF network element.

Based on the method shown in FIG. 5, the TMF network element may obtain the positioning information, and trigger the first access network device to perform inventory and positioning measurement on the at least one tag, to obtain the second measurement result. In this way, the LMF network element may obtain the location information of the at least one tag based on the second measurement result, to position the at least one tag, or the LMF network element obtains, based on the second measurement result, the location information of the first apparatus in which the at least one tag is located, to position the first apparatus.

An action of the TMF network element, the LMF network element, the first access network device, the second access network device, the first tag, or the second tag in S501 to S519 may be performed by the processor 301 in the communication apparatus 30 shown in FIG. 3 invoking the application program code stored in the memory 303. This is not limited in this embodiment of this application.

It may be understood that a function of the TMF network element in the method shown in FIG. 4 or FIG. 5 may alternatively be integrated into an existing core network element. For example, the TMF network element may be integrated into an AMF network element or the LMF network element. When the function of the TMF network element is integrated into the AMF network element, the at least one tag or the first apparatus may be positioned by using a method shown in FIG. 6 or FIG. 7. When the function of the TMF network element is integrated into the LMF network element, the at least one tag or the first apparatus may be positioned by using a method shown in FIG. 8 or FIG. 9.

FIG. 6 shows another positioning method according to an embodiment of this application. The positioning method may include the following steps.

S601: An AMF network element obtains positioning information.

The AMF network element may be the AMF network element 211 in FIG. 2B.

In a possible design, the positioning information may include information about at least one tag. The at least one tag may include any one or more tags. For example, the at least one tag includes the tag 213 and/or the tag 214 in FIG. 2B. The information about the at least one tag may include an identifier of the at least one tag or a group object of the at least one tag. For details, refer to the corresponding descriptions in S401.

In a possible implementation, the at least one tag is disposed on an apparatus, for example, a first apparatus. For details, refer to the corresponding descriptions in S401.

In a possible implementation, the positioning information further includes first information. The first information may include at least one of information about positioning precision, geographical area information of a first access network device, geographical area information of the at least one tag, information about a service type, information about a positioning periodicity, or an association identifier. For details, refer to the corresponding descriptions in S401.

In a possible implementation, the AMF network element may obtain the positioning information from another network element, for example, an AF network element. The AF network element may be the AF network element in FIG. 2D.

For example, the AMF network element receives the positioning information from the AF network element via a NEF network element. The NEF network element may be the NEF network element in FIG. 2D. It may be understood that the AF network element may send the positioning information to the NEF network element. After receiving the positioning information, the NEF network element may directly send the positioning information to the AMF network element, that is, the AF network element transparently transmits the positioning information to the AMF network element via the NEF network element. Alternatively, after receiving the positioning information, the NEF network element converts information in the positioning information into information that can be identified by the AMF network element, and sends the converted information to the AMF network element. For details, refer to the corresponding descriptions in S401.

In a possible implementation, the AMF network element determines, based on a preset condition, whether an LMF network element is required to assist in positioning the at least one tag. For details, refer to the corresponding descriptions in S401.

It may be understood that, if the AMF network element determines that the LMF network element is not required to assist in positioning the at least one tag, the AMF network element triggers the first access network device to inventory the at least one tag, obtains a first measurement result in an inventory process, and sends the first measurement result to the AMF network element, so that the AMF network element obtains location information of the at least one tag or location information of the first apparatus based on the first measurement result. For the foregoing process, refer to the following corresponding descriptions in S602 to S605. If the AMF network element determines that the LMF network element is required to assist in positioning the at least one tag, the AMF network element triggers the first access device to perform inventory and positioning measurement on the at least one tag, and sends a measurement result to the LMF network element, so that the LMF network element positions a first tag. The foregoing process is described in the embodiment shown in FIG. 7, and details are not described herein.

S602: The AMF network element sends a first inventory request to the first access network device. Correspondingly, the first access network device receives the first inventory request from the AMF network element.

S603: The first access network device sends a first message to the first tag. Correspondingly, the first tag receives the first message from the first access network device.

S604: The first tag sends a second message to the first access network device. Correspondingly, the first access network device receives the second message from the first tag.

S605: The first access network device sends the first measurement result to the AMF network element. Correspondingly, the AMF network element receives the first measurement result from the first access network device.

The first access network device may be the access network device 212 in FIG. 2B.

A process of S602 to S605 is similar to the process of S402 to S405. For details, refer to the corresponding descriptions in S402 to S405. Details are not described again.

Optionally, in a process of positioning the first tag, in addition to the first access network device, another access network device, for example, a second access network device, may be further required to assist the first access network device in positioning the first tag. For example, if the first measurement result includes the first phase information or the first angle information, the another access network device, for example, the second access network device, is further required to assist in positioning the first tag. For example, the method shown in FIG. 6 further includes S606 to S609.

S606: The AMF network element sends a second inventory request to the second access network device. Correspondingly, the second access network device receives the second inventory request from the AMF network element.

S607: The second access network device sends a seventh message to the first tag. Correspondingly, the first tag receives the seventh message from the second access network device.

S608: The first tag sends an eighth message to the second access network device. Correspondingly, the second access network device receives the eighth message from the first tag.

S609: The second access network device sends a fifth measurement result to the AMF network element. Correspondingly, the AMF network element receives the fifth measurement result from the second access network device.

A process of S606 to S609 is similar to the process of S406 to S409. Therefore, refer to the corresponding descriptions in S406 to S409. Details are not described again.

Optionally, if a quantity of the at least one tag is greater than 1, after S604, the first access network device may excite and power on a tag other than the first tag in the at least one tag. If a second tag is excited and powered on, the method shown in FIG. 6 further includes S610 to S612.

S610: The first access network device sends a ninth message to the second tag. Correspondingly, the second tag receives the ninth message from the first access network device.

S611: The second tag sends a tenth message to the first access network device. Correspondingly, the first access network device receives the tenth message from the second tag.

S612: The first access network device sends a sixth measurement result to the AMF network element. Correspondingly, the AMF network element receives the sixth measurement result from the first access network device.

S613: The AMF network element obtains the location information of the at least one tag, or obtains the location information of the first apparatus.

A process of S610 to S613 is similar to the process of S410 to S413. Therefore, refer to the corresponding descriptions in S410 to S413. Details are not described again.

Based on the method shown in FIG. 6, the AMF network element may obtain the positioning information, and trigger the first access network device to inventory the at least one tag, so that the first access network device obtains the first measurement result in the inventory process. In this way, the AMF network element may obtain the location information of the at least one tag based on the first measurement result, to position the at least one tag, or the AMF network element obtains, based on the first measurement result, the location information of the first apparatus in which the at least one tag is located, to position the first apparatus.

An action of the AMF network element, the first access network device, the second access network device, the first tag, or the second tag in S601 to S613 may be performed by the processor 301 in the communication apparatus 30 shown in FIG. 3 invoking the application program code stored in the memory 303. This is not limited in this embodiment of this application.

As described above, in the method shown in FIG. 6, the LMF network element does not participate in positioning of the at least one tag or the first apparatus. During specific application, the LMF network element may alternatively participate in positioning of a tag or an apparatus. For details, refer to a method shown in FIG. 7.

FIG. 7 shows another positioning method according to an embodiment of this application. The positioning method may include the following steps.

S701: An AMF network element obtains positioning information.

A process of S701 is similar to the process of S601. Therefore, refer to the corresponding descriptions in S601. Details are not described again.

Optionally, after S701, the AMF network element sends the positioning information to an LMF network element, so that the LMF network element may determine a to-be-used positioning measurement manner based on the positioning information. For descriptions of the positioning measurement manner, refer to the foregoing explanations and descriptions in the technical terms in this application. The LMF network element may be the LMF network element 216 in FIG. 2B.

Optionally, before the LMF network element determines the positioning measurement manner, a first access network device sends positioning assistance information to the LMF network element. Correspondingly, the LMF network element receives the positioning assistance information from the first access network device. The first access network device may be the access network device 212 in FIG. 2B. For descriptions of the positioning assistance information, refer to the corresponding descriptions in S501.

It may be understood that, after S701, the AMF network element may trigger the first access network device to perform inventory and positioning measurement on a tag in at least one tag, so that the first access network device sends a positioning measurement result to the LMF network element, and the LMF network element positions a first tag based on the positioning measurement result. For example, the AMF network element may trigger, in at least the following three manners, the first access network device to perform inventory and positioning measurement on the tag in the at least one tag.

Manner 4: The AMF network element sends a first inventory request to the first access network device. After receiving the first inventory request, the first access network device inventories the first tag. The AMF network element further sends a first positioning request to the LMF network element, to trigger the LMF network element to send a third positioning request to the first access network device, so that the first access network device performs positioning measurement on the first tag. For details, refer to the following descriptions in S702 to S706.

Manner 5: The AMF network element sends a first positioning request to the LMF network element, to trigger the LMF network element to send a third inventory request and a third positioning request to the first access network device, so that the first access network device performs inventory and positioning measurement on the first tag. This process is similar to the process in which in S502b to S506b, the TMF network element sends the first positioning request to the LMF network element, to trigger the LMF network element to send the third inventory request and the third positioning request to the first access network device, so that the first access network device performs inventory and positioning measurement on the first tag. For details, refer to the corresponding descriptions in S502b to S506b. Details are not described herein again.

Manner 6: The AMF network element sends a first positioning request to the LMF network element, to trigger the LMF network element to send a third positioning request to the first access network device, so that the first access network device performs inventory and positioning measurement on the first tag. This process is similar to the process in which in S502c to S505c, the TMF network element sends the first positioning request to the LMF network element, to trigger the LMF network element to send the third positioning request to the first access network device, so that the first access network device performs inventory and positioning measurement on the first tag. For details, refer to the corresponding descriptions in S502c to S505c. Details are not described herein again.

S702: The AMF network element sends the first inventory request to the first access network device. Correspondingly, the first access network device receives the first inventory request from the AMF network element.

S703: The first access network device sends a first message to the first tag. Correspondingly, the first tag receives the first message from the first access network device.

S704: The first tag sends a second message to the first access network device. Correspondingly, the first access network device receives the second message from the first tag.

S705: The AMF network element sends the first positioning request to the LMF network element. Correspondingly, the LMF network element receives the first positioning request from the AMF network element.

S706: The LMF network element sends the third positioning request to the first access network device. Correspondingly, the first access network device receives the third positioning request from the LMF network element.

S707: The first access network device sends an eleventh message to the first tag. Correspondingly, the first tag receives the eleventh message from the first access network device.

S708: The first tag sends a twelfth message to the first access network device. Correspondingly, the first access network device receives the twelfth message from the first tag.

S709: The first access network device sends a second measurement result to the LMF network element. Correspondingly, the LMF network element receives the second measurement result from the first access network device.

A process of S702 to S709 is similar to the process of S502a to S506a and S507 to S509. Therefore, refer to the corresponding descriptions in S502a to S506a and S507 to S509. Details are not described again.

Optionally, in a process of positioning the first tag, in addition to the first access network device, another access network device, for example, a second access network device, may be further required to assist the first access network device in positioning the first tag. The second access network device may be determined by the LMF network element, and is an access network device adjacent to the first access network device. For example, the method shown in FIG. 7 further includes S710 to S713.

S710: The LMF network element sends a fourth positioning request to the second access network device. Correspondingly, the second access network device receives the fourth positioning request from the LMF network element.

S711: The second access network device sends a thirteenth message to the first tag. Correspondingly, the first tag receives the thirteenth message from the second access network device.

S712: The first tag sends a fourteenth message to the second access network device. Correspondingly, the second access network device receives the fourteenth message from the first tag.

S713: The second access network device sends a third measurement result to the LMF network element. Correspondingly, the LMF network element receives the third measurement result from the second access network device.

A process of S710 to S713 is similar to the process of S510 to S513. Therefore, refer to the corresponding descriptions in S510 to S513. Details are not described again.

Optionally, if a quantity of the at least one tag is greater than 1, after S708, the first access network device may excite and power on a tag other than the first tag in the at least one tag. If a second tag is excited and powered on, the method shown in FIG. 7 further includes S714 to S718.

S714: The AMF network element sends a second positioning request to the LMF network element. Correspondingly, the LMF network element receives the second positioning request from the AMF network element.

S715: The LMF network element sends a fifth positioning request to the first access network device. Correspondingly, the first access network device receives the fifth positioning request from the LMF network element.

S716: The first access network device sends a fifth message to the second tag. Correspondingly, the second tag receives the fifth message from the first access network device.

S717: The second tag sends a sixth message to the first access network device. Correspondingly, the first access network device receives the sixth message from the second tag.

S718: The first access network device sends a fourth measurement result to the LMF network element. Correspondingly, the LMF network element receives the fourth measurement result from the first access network device.

S719: The LMF network element obtains location information of the at least one tag, or obtains location information of a first apparatus.

A process of S714 to S719 is similar to the process of S514 to S519. Therefore, refer to the corresponding descriptions in S514 to S519. Details are not described again.

Based on the method shown in FIG. 7, the AMF network element may obtain the positioning information, trigger the first access network device to inventory the at least one tag, and trigger the LMF network element to send the third positioning information to the first access network device, so that the first access network device measures a message sent by the first tag, to obtain the second measurement result. In this way, the LMF network element may obtain the location information of the at least one tag based on the second measurement result, to position the at least one tag, or the LMF network element obtains, based on the second measurement result, the location information of the first apparatus in which the at least one tag is located, to position the first apparatus.

An action of the AMF network element, the LMF network element, the first access network device, the second access network device, the first tag, or the second tag in S701 to S719 may be performed by the processor 301 in the communication apparatus 30 shown in FIG. 3 invoking the application program code stored in the memory 303. This is not limited in this embodiment of this application.

FIG. 8 shows another positioning method according to an embodiment of this application. The positioning method may include the following steps.

S801: An LMF network element obtains positioning information.

The LMF network element may be the LMF network element 221 in FIG. 2C.

In a possible design, the positioning information may include information about at least one tag. The at least one tag may include any one or more tags. For example, the at least one tag includes the tag 223 and/or the tag 224 in FIG. 2C. The information about the at least one tag may include an identifier of the at least one tag or a group object of the at least one tag. For details, refer to the corresponding descriptions in S401.

In a possible implementation, the at least one tag is disposed on an apparatus, for example, a first apparatus. For details, refer to the corresponding descriptions in S401.

In a possible implementation, the positioning information further includes first information. The first information may include at least one of information about positioning precision, geographical area information of a first access network device, geographical area information of the at least one tag, information about a service type, information about a positioning periodicity, or an association identifier. For details, refer to the corresponding descriptions in S401. The first access network device may be the access network device 222 in FIG. 2C.

In a possible implementation, the LMF network element may obtain the positioning information from another network element, for example, an AF network element. The AF network element may be the AF network element in FIG. 2D.

For example, the LMF network element receives the positioning information from the AF network element via a NEF network element. The NEF network element may be the NEF network element in FIG. 2D. It may be understood that the AF network element may send the positioning information to the NEF network element. After receiving the positioning information, the NEF network element may directly send the positioning information to the LMF network element, that is, the AF network element transparently transmits the positioning information to the LMF network element via the NEF network element. Alternatively, after receiving the positioning information, the NEF network element converts information in the positioning information into information that can be identified by the LMF network element, and sends the converted information to the LMF network element. For details, refer to the corresponding descriptions in S401.

S802: The LMF network element sends a first inventory request to the first access network device. Correspondingly, the first access network device receives the first inventory request from the LMF network element.

S803: The first access network device sends a first message to a first tag. Correspondingly, the first tag receives the first message from the first access network device.

S804: The first tag sends a second message to the first access network device. Correspondingly, the first access network device receives the second message from the first tag.

S805: The first access network device sends a first measurement result to the LMF network element. Correspondingly, the LMF network element receives the first measurement result from the first access network device.

A process of S802 to S805 is similar to the process of S402 to S405. Therefore, refer to the corresponding descriptions in S402 to S405. Details are not described again.

Optionally, in a process of positioning the first tag, in addition to the first access network device, another access network device, for example, a second access network device, may be further required to assist the first access network device in positioning the first tag. For example, if the first measurement result includes first phase information or first angle information, the another access network device, for example, the second access network device, is further required to assist in positioning the first tag. For example, the method shown in FIG. 8 further includes S806 to S809.

S806: The LMF network element sends a second inventory request to the second access network device. Correspondingly, the second access network device receives the second inventory request from the LMF network element.

S807: The second access network device sends a seventh message to the first tag. Correspondingly, the first tag receives the seventh message from the second access network device.

S808: The first tag sends an eighth message to the second access network device. Correspondingly, the second access network device receives the eighth message from the first tag.

S809: The second access network device sends a fifth measurement result to the LMF network element. Correspondingly, the LMF network element receives the fifth measurement result from the second access network device.

A process of S806 to S809 is similar to the process of S406 to S409. Therefore, refer to the corresponding descriptions in S406 to S409. Details are not described again.

Optionally, if a quantity of the at least one tag is greater than 1, after S804, the first access network device may excite and power on a tag other than the first tag in the at least one tag. If a second tag is excited and powered on, the method shown in FIG. 8 further includes S810 to S812.

S810: The first access network device sends a ninth message to the second tag. Correspondingly, the second tag receives the ninth message from the first access network device.

S811: The second tag sends a tenth message to the first access network device. Correspondingly, the first access network device receives the tenth message from the second tag.

S812: The first access network device sends a sixth measurement result to the LMF network element. Correspondingly, the LMF network element receives the sixth measurement result from the first access network device.

S813: The LMF network element obtains location information of the at least one tag, or obtains location information of the first apparatus.

A process of S810 to S813 is similar to the process of S410 to S413. Therefore, refer to the corresponding descriptions in S410 to S413. Details are not described again.

Based on the method shown in FIG. 8, the LMF network element may obtain the positioning information, and trigger the first access network device to inventory the at least one tag, so that the first access network device obtains the first measurement result in the inventory process. In this way, the LMF network element may obtain the location information of the at least one tag based on the first measurement result, to position the at least one tag, or the LMF network element obtains, based on the first measurement result, the location information of the first apparatus in which the at least one tag is located, to position the first apparatus.

An action of the LMF network element, the first access network device, the second access network device, the first tag, or the second tag in S801 to S813 may be performed by the processor 301 in the communication apparatus 30 shown in FIG. 3 invoking the application program code stored in the memory 303. This is not limited in this embodiment of this application.

FIG. 9 shows another positioning method according to an embodiment of this application. The positioning method may include the following steps.

S901: An LMF network element obtains positioning information.

A process of S901 is similar to the process of S801. Therefore, refer to the corresponding descriptions in S801. Details are not described again.

Optionally, after S901, the LMF network element may determine a to-be-used positioning measurement manner based on the positioning information. For descriptions of the positioning measurement manner, refer to the foregoing explanations and descriptions in the technical terms in this application.

Optionally, before the LMF network element determines the positioning measurement manner, a first access network device sends positioning assistance information to the LMF network element. Correspondingly, the LMF network element receives the positioning assistance information from the first access network device.

The first access network device may be the access network device 222 in FIG. 2C. For descriptions of the positioning assistance information, refer to the corresponding descriptions in S501.

S902: The LMF network element sends a first inventory request to the first access network device. Correspondingly, the first access network device receives the first inventory request from the LMF network element.

S903: The first access network device sends a first message to a first tag. Correspondingly, the first tag receives the first message from the first access network device.

S904: The first tag sends a second message to the first access network device. Correspondingly, the first access network device receives the second message from the first tag.

A process of S902 to S904 is similar to the process of S502a to S504a. Therefore, refer to the corresponding descriptions in S502a to S504a. Details are not described again.

S905: The LMF network element sends a third positioning request to the first access network device. Correspondingly, the first access network device receives the third positioning request from the LMF network element.

S906: The first access network device sends an eleventh message to the first tag. Correspondingly, the first tag receives the eleventh message from the first access network device.

S907: The first tag sends a twelfth message to the first access network device. Correspondingly, the first access network device receives the twelfth message from the first tag.

S908: The first access network device sends a second measurement result to the LMF network element. Correspondingly, the LMF network element receives the second measurement result from the first access network device.

A process of S905 to S908 is similar to the process of S506a and S507 to S509. Therefore, refer to the corresponding descriptions in S506a and S507 to S509. Details are not described again.

It may be understood that S902 to S904 are optional steps. When S902 to S904 are included, the first tag may be inventoried by using S903 and S904, and positioning measurement may be performed on the first tag by using S906 and S907. When S902 to S904 are not included, inventory and positioning measurement may be performed on the first tag by using S906 and S907.

Optionally, in a process of positioning the first tag, in addition to the first access network device, another access network device, for example, a second access network device, may be further required to assist the first access network device in positioning the first tag. The second access network device may be determined by the LMF network element, and is an access network device adjacent to the first access network device. For example, the method shown in FIG. 9 further includes S909 to S912.

S909: The LMF network element sends a fourth positioning request to the second access network device. Correspondingly, the second access network device receives the fourth positioning request from the LMF network element.

S910: The second access network device sends a thirteenth message to the first tag. Correspondingly, the first tag receives the thirteenth message from the second access network device.

S911: The first tag sends a fourteenth message to the second access network device. Correspondingly, the second access network device receives the fourteenth message from the first tag.

S912: The second access network device sends a third measurement result to the LMF network element. Correspondingly, the LMF network element receives the third measurement result from the second access network device.

A process of S909 to S912 is similar to the process of S510 to S513. Therefore, refer to the corresponding descriptions in S510 to S513. Details are not described again.

Optionally, if a quantity of the at least one tag is greater than 1, after S907, the first access network device may excite and power on a tag other than the first tag in the at least one tag. If a second tag is excited and powered on, the method shown in FIG. 9 further includes S913 to S916.

S913: The LMF network element sends a fifth positioning request to the first access network device. Correspondingly, the first access network device receives the fifth positioning request from the LMF network element.

S914: The first access network device sends a fifth message to the second tag. Correspondingly, the second tag receives the fifth message from the first access network device.

S915: The second tag sends a sixth message to the first access network device. Correspondingly, the first access network device receives the sixth message from the second tag.

S916: The first access network device sends a fourth measurement result to the LMF network element. Correspondingly, the LMF network element receives the fourth measurement result from the first access network device.

S917: The LMF network element obtains location information of the at least one tag, or obtains location information of a first apparatus.

A process of S913 to S917 is similar to the process of S515 to S519. Therefore, refer to the corresponding descriptions in S515 to S519. Details are not described again.

Based on the method shown in FIG. 9, the LMF network element may obtain the positioning information, and trigger the first access network device to measure a message sent by the first tag, to obtain the second measurement result. In this way, the LMF network element may obtain the location information of the at least one tag based on the second measurement result, to position the at least one tag, or the LMF network element obtains, based on the second measurement result, the location information of the first apparatus in which the at least one tag is located, to position the first apparatus.

An action of the LMF network element, the first access network device, the second access network device, the first tag, or the second tag in S901 to S917 may be performed by the processor 301 in the communication apparatus 30 shown in FIG. 3 invoking the application program code stored in the memory 303. This is not limited in this embodiment of this application.

In addition to the foregoing method, an embodiment of this application further provides a communication method. In the method, a first message may be used to trigger a first tag to send a second message, so that a first access network device performs positioning measurement based on the second message, to position the first tag.

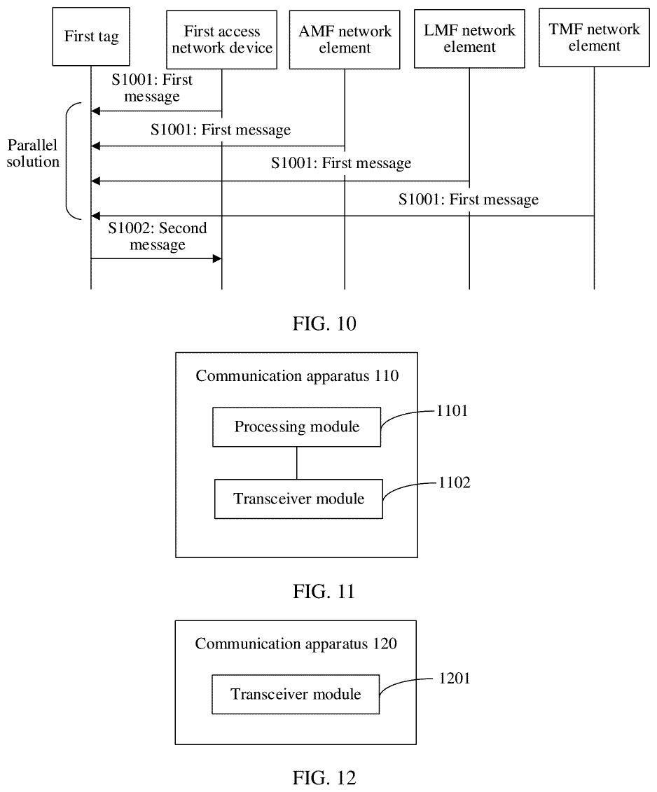

FIG. 10 shows a communication method according to an embodiment of this application. The positioning method may include the following steps.

S1001: A network device sends a first message to a first tag. Correspondingly, the first tag receives the first message from the network device.

The network device may be a first access network device or a core network device. The core network device includes a TMF network element, an LMF network element, or an AMF network element. The first tag may be any tag that can communicate with the network device.

For example, the network device is the TMF network element 201, the LMF network element 206, or the access network device 202 in FIG. 2A, and the first tag is the tag 203 or the tag 204 in FIG. 2A. Alternatively, the network device is the AMF network element 211, the LMF network element 216, or the access network device 212 in FIG. 2B, and the first tag is the tag 213 or the tag 214 in FIG. 2B. Alternatively, the network device is the LMF network element 221 or the access network device 222 in FIG. 2C, and the first tag is the tag 223 or the tag 224 in FIG. 2C. Alternatively, the network device is the AMF network element, the LMF network element, the TMF network element, or the access network device in FIG. 2D, and the first tag is any tag in FIG. 2D.

In a possible design, the first message is used to trigger the first tag to reflect or reply to a received message. For example, the first message is a selection message, an acknowledgment message, a query message, a query message-like message, a message for triggering the first tag to send a reflection signal, a positioning message, or a sequence number request message.

For descriptions of the selection message, the acknowledgment message, the query message, the query message-like message, the message for triggering the first tag to send the reflection signal, and the sequence number request message, refer to the corresponding descriptions in S403. The positioning message may be used to trigger the first tag to return location information of the first tag. For example, the positioning message includes an identifier, where the identifier indicates the first tag to return the location information of the first tag.

In a possible implementation, the first tag switches a switch in the first tag to a first location based on the first message, so that the first tag directly reflects the received message. In other words, the first tag is switched from a normal reply mode to a reflection mode based on the first message. In the reflection mode, the first tag may not parse the received message, but directly replies with a signal. In this way, a communication delay can be reduced, and power consumption of the first tag can be reduced.

The tag shown in FIG. 1 is used as an example. Before the first message is received, a switch of the tag is at a location 1, the tag is in the normal reply mode, and a signal may be parsed by a decoding module. After the tag receives the first message, the decoding module parses the first message, and determines that the first message is used to trigger the first tag to reflect the received message. For example, a header of the first message carries indication information, and the indication information indicates the foregoing function. The decoding module may determine, by parsing the header of the first message, that the first message has the foregoing function, and send a command to a control module, to indicate the control module to switch the switch from the location 1 to a location 2. After receiving the command, the control module switches the switch from the location 1 to the location 2. After the switch is switched to the location 2, the tag is in the reflection mode, and a modulation module may directly reply with a message without parsing the received message.

S1002: The first tag sends a second message to the first access network device. Correspondingly, the first access network device receives the second message from the first tag.

A signal carrying the second message is used by the first access network device to perform measurement. For example, the first access network device measures the signal carrying the second message, to obtain a measurement result, and sends the measurement result to the core network device. Alternatively, the second message is forwarded by the first access network device. For example, the first access network device forwards the second message to the core network device.

In a possible design, the second message is a reflection message for the first message, or the second message carries an identifier of the first tag, a random number, a sequence number, a check code, random number-like information, sequence number-like information, or check code-like information.

It may be understood that, if the first message is a selection message, the second message includes an RN16 random number or carries the identifier of the first tag. If the first message is an acknowledgment message, the second message includes the identifier of the first tag. If the first message is a query message, the second message includes an RN16 random number, a sequence number, or a check code. If the first message is a query message-like message, the second message includes RN16 random number-like information, sequence number-like information, or check code-like information. If the first message is a message for triggering the first tag to send a reflection signal, the second message is carried in the reflection signal, that is, the second message is a reflection message for the first message. If the first message is a positioning message, the second message includes the location information of the first tag. If the first message is a sequence number request message, the second message includes a sequence number.

Optionally, the method shown in FIG. 1 may be combined with the positioning method provided in embodiments of this application, to indicate the tag in the positioning method to switch from the normal reply mode to the reflective mode, thereby reducing a communication delay. Specifically, the methods shown in FIG. 4 to FIG. 9 may further include S1001, or include S1001 and S1002. Alternatively, steps in the methods shown in FIG. 4 to FIG. 9 may be replaced with S1001, or may be replaced with S1001 and S1002. The method shown in FIG. 5 is used as an example. S1001 may be performed before S503a. Alternatively, S503a and S504a or S507 and S508 may be replaced with S1001 and S1002.

Various embodiments mentioned above in this application may be combined when the solutions do not conflict. This is not limited.

It may be understood that in the foregoing embodiments, the method and/or the step implemented by the TMF network element may alternatively be implemented by a component (for example, a chip or a circuit) that can be used for the TMF network element, the method and/or the step implemented by the AMF network element may alternatively be implemented by a component (for example, a chip or a circuit) that can be used for the AMF network element, the method and/or the step implemented by the LMF network element may alternatively be implemented by a component (for example, a chip or a circuit) that can be used for the LMF network element, the method and/or the step implemented by the first access network device may alternatively be implemented by a component (for example, a chip or a circuit) that can be used for the first access network device, and the method and/or the step implemented by the first tag may alternatively be implemented by a component (for example, a chip or a circuit) that can be used for the first tag.

The foregoing mainly describes the solutions provided in embodiments of this application from a perspective of interaction between network elements. Correspondingly, an embodiment of this application further provides a communication apparatus. The communication apparatus may be the TMF network element in the foregoing method embodiments, an apparatus including the TMF network element, or a component that can be used for the TMF network element. Alternatively, the communication apparatus may be the AMF network element in the foregoing method embodiments, an apparatus including the AMF network element, or a component that can be used for the AMF network element. Alternatively, the communication apparatus may be the LMF network element in the foregoing method embodiments, an apparatus including the LMF network element, or a component that can be used for the LMF network element. Alternatively, the communication apparatus may be the first access network device in the foregoing method embodiments, an apparatus including the first access network device, or a component that can be used for the first access network device. Alternatively, the communication apparatus may be the first tag in the foregoing method embodiments, an apparatus including the first tag, or a component that can be used for the first tag. It may be understood that, to implement the foregoing functions, the TMF network element, the AMF network element, the LMF network element, the first access network device, the first tag, or the like includes corresponding hardware structures and/or software modules for performing the functions. A person skilled in the art should be easily aware that, in combination with units and algorithm operations of the examples described in embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the TMF network element, the AMF network element, the LMF network element, the first access network device, the first tag, or the like may be divided into functional modules according to the foregoing method examples. For example, each functional module may be obtained through division based on each corresponding function, or two or more functions may be integrated into one processing module. The integrated module may be implemented in a form of hardware, or may be implemented in a form of a software functional module. It may be understood that, in embodiments of this application, division into modules is used as an example, and is merely logical function division, and there may be another division manner during actual implementation.

For example, when each functional module is obtained through division in an integrated manner, FIG. 11 is a diagram of a structure of a communication apparatus 110. The communication apparatus 110 includes a processing module 1101 and a transceiver module 1102. The processing module 1101 may also be referred to as a processing unit, is configured to perform an operation other than receiving and sending operations, and may be, for example, a processing circuit or a processor. The transceiver module 1102 may also be referred to as a transceiver unit, is configured to perform the sending and receiving operations, and may be, for example, a transceiver circuit, a transceiver machine, a transceiver, or a communication interface.

In some embodiments, the communication apparatus 110 may further include a storage module (which is not shown in FIG. 11), configured to store program instructions and data.

For example, the communication apparatus 110 is configured to implement a function of a TMF network element, an LMF network element, or an AMF network element. The communication apparatus 110 is, for example, the TMF network element in the embodiment shown in FIG. 4 or the embodiment shown in FIG. 5. Alternatively, the communication apparatus 110 is, for example, the AMF network element in the embodiment shown in FIG. 6 or the embodiment shown in FIG. 7. Alternatively, the communication apparatus 110 is, for example, the LMF network element in the embodiment shown in FIG. 8 or the embodiment shown in FIG. 9.

The processing module 1101 is configured to obtain positioning information. The positioning information includes information about at least one tag. For example, the processing module 1101 may be configured to perform S401, S501, S601, S701, or S801.

The transceiver module 1102 is configured to send a first inventory request to a first access network device. The first inventory request is used to request to inventory the at least one tag, the first inventory request includes the information about the at least one tag, and the first access network device provides a service for the at least one tag. For example, the transceiver module 1102 may be configured to perform S402, S502a, S602, S702, S802, or S902.

The processing module 1101 is further configured to obtain location information of the at least one tag, or obtain location information of a first apparatus, where the at least one tag is disposed on the first apparatus. For example, the processing module 1101 may be further configured to perform S413, S519, S613, S719, S813, or S917.

In a possible implementation, the positioning information further includes at least one of information about positioning precision, geographical area information of the first access network device, information about a service type, information about a positioning periodicity, or an association identifier.

In a possible implementation, the service type includes a single inventory, a continuous inventory, or a periodic inventory, and the association identifier identifies information related to positioning and/or the inventory of the at least one tag.

In a possible implementation, the at least one tag includes a first tag, and the transceiver module 1102 is further configured to send a first positioning request to a location management function network element, where the first positioning request is used to request to position the first tag, and the first positioning request includes an identifier of the first tag.

In a possible implementation, the first positioning request further includes at least one of type information of the first tag or information about a service type of the first tag.

In a possible implementation, the transceiver module 1102 is specifically configured to periodically send the first positioning request to the location management function network element.

In a possible implementation, the at least one tag further includes a second tag, and the processing module 1101 is specifically configured to receive the location information of the first apparatus from the location management function network element through the transceiver module 1102, where the location information of the first apparatus is obtained based on the location information of the first tag and location information of the second tag.

In a possible implementation, the transceiver module 1102 is further configured to send a second positioning request to the location management function network element, where the second positioning request is used to request to position the second tag, and the second positioning request includes an identifier of the second tag.

In a possible implementation, the at least one tag includes a first tag, and the processing module 1101 is specifically configured to receive a first measurement result from the first access network device through the transceiver module 1102, where the first measurement result is obtained by the first access network device in a process of inventorying the first tag, and the first measurement result is used to determine location information of the first tag.

In a possible implementation, the first measurement result includes at least one of an identifier of a first cell, a first time difference, first phase information, or first angle information, and the first cell is a serving cell in which the first access network device provides a service for the first tag, the first time difference is a time difference between time at which the first access network device sends a first message to the first tag and time at which the first access network device receives a second message from the first tag, the first phase information indicates a carrier phase of a signal carrying the second message or indicates a carrier phase of a signal carrying the first message and a carrier phase of a signal carrying the second message, and the first angle information indicates an angle of arrival of the signal carrying the second message.

In a possible implementation, the transceiver module 1102 is further configured to send the location information of the at least one tag to an application function network element, or send the location information of the first apparatus to an application function network element.

In a possible implementation, the at least one tag includes a first tag, and the transceiver module 1102 is further configured to send a third message to the first tag, where the third message is used to trigger the first tag to send a fourth message to the first access network device, so that the first access network device measures a signal carrying the fourth message.

In a possible implementation, the third message is a selection message, an acknowledgment message, a query message, a query message-like message, a message for triggering the first tag to send a reflection signal, a positioning message, or a sequence number request message.

In a possible implementation, the processing module 1101 is specifically configured to receive the location information of the first tag from the location management function network element through the transceiver module 1102.

In a possible implementation, any one of the at least one tag is a passive terminal or a semi-passive terminal.

When functions of the TMF network element, the LMF network element, or the AMF network element are implemented, for other functions that can be implemented by the communication apparatus 110, refer to the related descriptions of the embodiment shown in FIG. 4 to the embodiment shown in FIG. 9. Details are not described again.

In a simple embodiment, a person skilled in the art may figure out that the communication apparatus 110 may be in the form shown in FIG. 3. For example, the processor 301 in FIG. 3 may invoke the computer-executable instructions stored in the memory 303, to enable the communication apparatus 110 to perform the methods in the foregoing method embodiments.

For example, functions/implementation processes of the processing module 1101 and the transceiver module 1102 in FIG. 11 may be implemented by the processor 301 in FIG. 3 invoking the computer-executable instructions stored in the memory 303. Alternatively, functions/implementation processes of the processing module 1101 in FIG. 11 may be implemented by the processor 301 in FIG. 3 invoking the computer-executable instructions stored in the memory 303. Functions/implementation processes of the transceiver module 1102 in FIG. 11 may be implemented by the communication interface 304 in FIG. 3.

For example, when each functional module is obtained through division in an integrated manner, FIG. 12 is a diagram of a structure of a communication apparatus 120. The communication apparatus 120 includes a transceiver module 1201. The transceiver module 1201 may also be referred to as a transceiver unit, is configured to perform the sending and receiving operations, and may be, for example, a transceiver circuit, a transceiver machine, a transceiver, or a communication interface.

In some embodiments, the communication apparatus 120 may further include a storage module (which is not shown in FIG. 9), configured to store program instructions and data.

For example, the communication apparatus 120 is configured to implement a function of an LMF network element. The communication apparatus 120 is, for example, the LMF network element in the embodiment shown in FIG. 5 or the embodiment shown in FIG. 7.

The transceiver module 1201 is configured to receive a first positioning request, where the first positioning request is used to request to position a first tag, and the first positioning request includes an identifier of the first tag. For example, the transceiver module 1201 may be configured to perform S505a, S502b, and S705.

The transceiver module 1201 is further configured to send a third positioning request to a first access network device. The third positioning request is used to request to position the first tag, the third positioning request includes the identifier of the first tag, and the first access network device provides a service for the first tag. For example, the transceiver module 1201 may be configured to perform S506a, S506b, S503c, or S706.

The transceiver module 1201 is further configured to receive a second measurement result from the first access network device. The second measurement result is used to determine location information of the first tag. For example, the transceiver module 1201 may be configured to perform S509 or S709.

In a possible implementation, the transceiver module 1201 is further configured to send a fourth positioning request to a second access network device, where the fourth positioning request is used to request the second access network device to position the first tag, and the fourth positioning request includes the identifier of the first tag, and the transceiver module 1201 is further configured to receive a third measurement result from the second access network device, where the third measurement result and the second measurement result are jointly used to determine the location information of the first tag.

In a possible implementation, the first positioning request further includes at least one of type information of the first tag or information about a service type of the first tag.

In a possible implementation, the third positioning request further includes at least one of information about a positioning measurement manner, the type information of the first tag, or the information about the service type of the first tag.

In a possible implementation, the positioning measurement manner includes angle measurement, phase measurement, signal strength measurement, multi-antenna measurement, fingerprint positioning measurement, or multi-tag assistance positioning measurement.

In a possible implementation, the second measurement result is obtained by the first access network device by performing measurement in the positioning measurement manner.

In a possible implementation, the transceiver module 1201 is specifically configured to periodically send a second positioning request to the first access network device.

In a possible implementation, the transceiver module 1201 is further configured to send the location information of the first tag to a tag management function network element.

In a possible implementation, the transceiver module 1201 is further configured to receive the second positioning request, where the second positioning request is used to request to position a second tag, and the second positioning request includes an identifier of the second tag, the transceiver module 1201 is further configured to send a fifth positioning request to the first access network device, where the fifth request is used to request to position the second tag, the fifth positioning request includes the identifier of the second tag, and the first access network device further provides a service for the second tag, and the transceiver module 1201 is further configured to receive a fourth measurement result from the first access network device, where the fourth measurement result is used to determine location information of the second tag.

In a possible implementation, the transceiver module 1201 is further configured to send location information of a first apparatus to the tag management function network element, where the first tag and the second tag are disposed on the first apparatus, and the location information of the first apparatus is obtained based on the location information of the first tag and the location information of the second tag.

In a possible implementation, the location information of the first apparatus is an average value of the location information of the first tag and the location information of the second tag.

In a possible implementation, the transceiver module 1201 is further configured to receive positioning assistance information from the first access network device, where the positioning assistance information includes at least one of location information of the first access network device, height information of the first access network device, or information about at least one positioning measurement manner supported by the first access network device.

In a possible implementation, the first tag is a passive terminal or a semi-passive terminal.

In a possible implementation, the second tag is a passive terminal or a semi-passive terminal.

When a function of the LMF network element is implemented, for another function that can be implemented by the communication apparatus 120, refer to the related descriptions of the embodiment shown in FIG. 5 or the embodiment shown in FIG. 7. Details are not described again herein.

Alternatively, for example, the communication apparatus 120 is configured to implement a function of the first access network device. For example, the communication apparatus 120 is the first access network device in the embodiment shown in FIG. 4, the embodiment shown in FIG. 5, the embodiment shown in FIG. 6, the embodiment shown in FIG. 7, the embodiment shown in FIG. 8, or the embodiment shown in FIG. 9.

The transceiver module 1201 is configured to receive a first inventory request. The first inventory request is used to request to inventory at least one tag, the first inventory request includes information about the at least one tag, and the at least one tag includes a first tag. For example, the transceiver module 1201 may be configured to perform S402, S502a, S602, S702, S802, or S902.

The transceiver module 1201 is further configured to send a first message to the first tag. For example, the transceiver module 1201 may be configured to perform S403, S503a, S603, S703, S803, or S903.

The transceiver module 1201 is further configured to receive a second message from the first tag. For example, the transceiver module 1201 may be configured to perform S402, S504a, S604, S704, S804, or S904.

The transceiver module 1201 is further configured to send a first measurement result, where the first measurement result is used to determine location information of the first tag. For example, the transceiver module 1201 is further configured to perform S405, S509, S605, S709, S805, or S908.

In a possible implementation, the transceiver module 1201 is further configured to receive a third positioning request from a location management function network element, where the third positioning request is used to request to position the first tag, and the third positioning request includes an identifier of the first tag.

In a possible implementation, the third positioning request further includes at least one of information about a positioning measurement manner, type information of the first tag, or information about a service type of the first tag.

In a possible implementation, the first measurement result is obtained by the communication apparatus 120 by performing measurement in a measurement manner indicated by the information about the positioning measurement manner.

In a possible implementation, the transceiver module 1201 is specifically configured to periodically receive the third positioning request from the location management function network element.

In a possible implementation, the first measurement result includes at least one of an identifier of a first cell, a first time difference, first phase information, or first angle information, and the first cell is a serving cell in which the communication apparatus 120 provides a service for the first tag, the first time difference is a time difference between time at which the communication apparatus 120 sends a first message to the first tag and time at which the communication apparatus 120 receives a second message from the first tag, the first phase information indicates a carrier phase of a signal carrying the second message or indicates a carrier phase of a signal carrying the first message and a carrier phase of a signal carrying the second message, and the first angle information indicates an angle of arrival of the signal carrying the second message.

In a possible implementation, the at least one tag further includes a second tag, and the transceiver module 1201 is further configured to send a fifth message to the second tag, the transceiver module 1201 is further configured to receive a sixth message from the second tag, and the transceiver module 1201 is further configured to send a fourth measurement result, where the fourth measurement result is used to determine location information of the second tag.

In a possible implementation, the transceiver module 1201 is further configured to receive a fifth positioning request from the location management function network element, where the fifth positioning request is used to request to position the second tag, and the fifth positioning request includes an identifier of the second tag.

In a possible implementation, the fifth positioning request further includes at least one of information about a positioning measurement manner, type information of the second tag, or information about a service type of the second tag.

In a possible implementation, the fourth measurement result is obtained by the communication apparatus 120 by performing measurement in the positioning measurement manner indicated by the fifth positioning request.

In a possible implementation, the positioning measurement manner includes angle measurement, phase measurement, signal strength measurement, multi-antenna measurement, fingerprint positioning measurement, or multi-tag assistance positioning measurement.

In a possible implementation, the transceiver module 1201 is further configured to send positioning assistance information to the location management function network element, where the positioning assistance information includes at least one of location information of the communication apparatus 120, height information of the communication apparatus 120, or information about at least one positioning measurement manner supported by the communication apparatus 120.

In a possible implementation, the first message is a selection message, an acknowledgment message, a query message, a query message-like message, a message for triggering the first tag to send a reflection signal, or a sequence number request message.

In a possible implementation, the first tag is a passive terminal or a semi-passive terminal.

In a possible implementation, the second tag is a passive terminal or a semi-passive terminal.

When a function of the first access network device is implemented, for another function that can be implemented by the communication apparatus 120, refer to the related descriptions of the embodiment shown in FIG. 4, the embodiment shown in FIG. 5, the embodiment shown in FIG. 6, the embodiment shown in FIG. 7, the embodiment shown in FIG. 8, or the embodiment shown in FIG. 9. Details are not described again.

In a simple embodiment, a person skilled in the art may figure out that the communication apparatus 120 may be in the form shown in FIG. 3. For example, the processor 301 in FIG. 3 may invoke the computer-executable instructions stored in the memory 303, to enable the communication apparatus 120 to perform the methods in the foregoing method embodiments.

For example, functions/implementation processes of the transceiver module 1201 in FIG. 12 may be implemented by the processor 301 in FIG. 3 invoking the computer-executable instructions stored in the memory 303. Alternatively, functions/implementation processes of the transceiver module 1201 in FIG. 12 may be implemented by the communication interface 304 in FIG. 3.

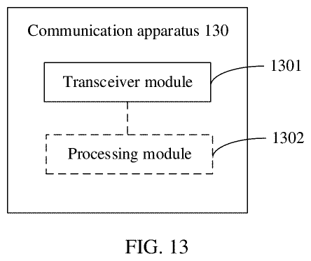

For example, when each functional module is obtained through division in an integrated manner, FIG. 13 is a diagram of a structure of a communication apparatus 130. The communication apparatus 130 includes a transceiver module 1301. The transceiver module 1301 may also be referred to as a transceiver unit, is configured to perform sending and receiving operations, and may be, for example, a transceiver circuit, a transceiver machine, a transceiver, or a communication interface. Optionally, the communication apparatus 130 further includes a processing module 1302. The processing module 1302 may also be referred to as a processing unit, is configured to perform an operation other than the sending and receiving operations, and may be, for example, a processing circuit or a processor.

In some embodiments, the communication apparatus 130 may further include a storage module (which is not shown in FIG. 9), configured to store program instructions and data.

For example, the communication apparatus 130 is configured to implement a function of a tag. The communication apparatus 130 is, for example, the first tag in the embodiment shown in FIG. 10.

The transceiver module 1301 is configured to receive a first message. The first message is used to trigger the communication apparatus 130 to reflect or reply to a received message. For example, the transceiver module 1301 may be configured to perform S1001.

The transceiver module 1301 is further configured to send a second message to a first access network device. A signal carrying the second message is used by the first access network device to perform positioning measurement. For example, the transceiver module 1301 may be further configured to perform S1002.

In a possible implementation, the processing module 1302 is configured to switch a switch in the communication apparatus 130 to a first location based on the first message, so that the communication apparatus 130 directly reflects the received message.

In a possible implementation, the first message is a selection message, an acknowledgment message, a query message, a query message-like message, a message for triggering the communication apparatus 130 to send a reflection signal, a positioning message, or a sequence number request message.

In a possible implementation, the second message is a reflection message for the first message, or the second message carries an identifier of the communication apparatus 130, a random number, a sequence number, a check code, random number-like information, sequence number-like information, or check code-like information.

In a possible implementation, the transceiver module 1301 is specifically configured to receive the first message from a core network element, or the transceiver module 1301 is specifically configured to receive the first message from the first access network device.

In a possible implementation, the core network element is an access and mobility management function network element, a location management function network element, or a tag management function network element.

In a possible implementation, the communication apparatus 130 is a passive terminal or a semi-passive terminal.

When a function of the first tag is implemented, for another function that can be implemented by the communication apparatus 130, refer to the related descriptions of the embodiment shown in FIG. 10. Details are not described again herein.

In a simple embodiment, a person skilled in the art may figure out that the communication apparatus 130 may be in the form shown in FIG. 3. For example, the processor 301 in FIG. 3 may invoke the computer-executable instructions stored in the memory 303, to enable the communication apparatus 130 to perform the methods in the foregoing method embodiments.

For example, functions/implementation processes of the transceiver module 1301 and the processing module 1302 in FIG. 13 may be implemented by the processor 301 in FIG. 3 invoking the computer-executable instructions stored in the memory 303. Alternatively, functions/implementation processes of the processing module 1302 in FIG. 13 may be implemented by the processor 301 in FIG. 3 invoking the computer-executable instructions stored in the memory 303. Functions/implementation processes of the transceiver module 1301 in FIG. 13 may be implemented by the communication interface 304 in FIG. 3.

It may be understood that one or more of the foregoing modules or units may be implemented by software, hardware, or a combination thereof. When any one of the foregoing modules or units is implemented by software, the software exists in a form of computer program instructions, and is stored in the memory. The processor may be configured to execute the program instructions and implement the foregoing method procedures. The processor may be built into a SoC (system on chip) or an ASIC, or may be an independent semiconductor chip. In addition to a core configured to perform calculation or processing by executing software instructions, the processor may further include a necessary hardware accelerator, for example, a field programmable gate array (FPGA), a PLD (programmable logic device), or a logic circuit that implements a dedicated logic operation.

When the foregoing modules or units are implemented by hardware, the hardware may be any one or any combination of a CPU, a microprocessor, a digital signal processor (digital signal processing, DSP) chip, a microcontroller unit (MCU), an artificial intelligence processor, an ASIC, a SoC, an FPGA, a PLD, a dedicated digital circuit, a hardware accelerator, or a non-integrated discrete device, and the hardware may run necessary software or does not depend on software to perform the foregoing method procedures.

Optionally, an embodiment of this application further provides a chip system, including at least one processor and an interface, where the at least one processor is coupled to a memory through an interface, and when the at least one processor executes a computer program or instructions in the memory, the method in any one of the foregoing method embodiments is performed. In a possible implementation, the chip system further includes the memory. Optionally, the chip system may include a chip, or may include a chip and another discrete device. This is not specifically limited in this embodiment of this application.

Optionally, an embodiment of this application further provides a computer-readable storage medium. All or some of the procedures in the foregoing method embodiments may be implemented by a computer program instructing related hardware. The program may be stored in the computer-readable storage medium. When the program is executed, the procedures of the foregoing method embodiments may be included. The computer-readable storage medium may be an internal storage unit of the communication apparatus in any one of the foregoing embodiments, for example, a hard disk or a memory of the communication apparatus. Alternatively, the computer-readable storage medium may be an external storage device of the communication apparatus, for example, a plug-in hard disk, a smart media card (SMC), a secure digital (SD) card, or a flash card that is configured on the communication apparatus. Further, the computer-readable storage medium may include both an internal storage unit and an external storage device of the communication apparatus. The computer-readable storage medium is configured to store the computer program and store other programs and data that are required by the communication apparatus. The computer-readable storage medium may be further configured to temporarily store data that has been output or is to be output.

Optionally, an embodiment of this application further provides a computer program product. All or some of the procedures in the foregoing method embodiments may be implemented by a computer program instructing related hardware. The program may be stored in the computer program product. When the program is executed, the procedures of the foregoing method embodiments may be included.

Optionally, an embodiment of this application further provides computer instructions. All or some of the procedures in the foregoing method embodiments may be implemented by computer instructions instructing related hardware (such as a computer, a processor, an access network device, a mobility management network element, or a session management network element). The program may be stored in the computer-readable storage medium or the computer program product.

Optionally, an embodiment of this application further provides a communication system, including the first access network device and the first tag in the foregoing embodiments. The communication system further includes the TMF network element, and/or the AMF network element, and/or the LMF network element in the foregoing embodiments.

The foregoing descriptions about implementations allow a person skilled in the art to understand that, for the purpose of convenient and brief description, division of the foregoing functional modules is taken as an example for illustration. In actual application, the foregoing functions can be allocated to different modules and implemented according to a requirement, that is, an inner structure of an apparatus is divided into different functional modules to implement all or some of the functions described above.

In the several embodiments provided in this application, it should be understood that the disclosed apparatus and method may be implemented in other manners. For example, the described apparatus embodiments are merely examples. For example, division into the modules or units is merely logical function division, and may be other division during actual implementation. For example, a plurality of units or components may be combined or may be integrated into another apparatus, or some features may be ignored or not performed. In addition, the displayed or discussed mutual couplings or direct couplings or communication connections may be implemented through some interfaces. The indirect couplings or communication connections between the apparatuses or the units may be implemented in electrical, mechanical, or another form.

The units described as separate parts may or may not be physically separate, and parts displayed as units may be one or more physical units, that is, may be located in one place, or may be distributed in a plurality of different places. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit. The integrated unit may be implemented in a form of hardware, or may be implemented in a form of a software functional unit.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A positioning method, comprising:
obtaining positioning information, wherein the positioning information comprises information about at least one tag;
sending a first inventory request to a first access network device, wherein the first inventory request requests to inventory the at least one tag, wherein the first inventory request comprises the information about the at least one tag, and wherein the first access network device provides a service for the at least one tag; and
obtaining location information of the at least one tag, or a first apparatus on which the at least one tag is disposed.

2. The method according to claim 1, wherein the positioning information further comprises at least one of information about positioning precision, geographical area information of the first access network device, information about a service type, information about a positioning periodicity, or an association identifier.

3. The method according to claim 2, wherein the service type comprises a single inventory, a continuous inventory, or a periodic inventory, and wherein the association identifier identifies information related to positioning or the inventory of the at least one tag.

4. The method according to claim 1, wherein the at least one tag comprises a first tag;
wherein the method further comprises:
sending a first positioning request to a location management function network element, wherein the first positioning request requests to position the first tag, and wherein the first positioning request comprises an identifier of the first tag; and
wherein the obtaining location information of the at least one tag comprises:
receiving location information of the first tag from the location management function network element.

5. The method according to claim 4, wherein the first positioning request further comprises at least one type information of the first tag or information about a service type of the first tag.

6. The method according to claim 4, wherein the at least one tag further comprises a second tag, and wherein the obtaining the location information of the first apparatus comprises:
receiving the location information of the first apparatus from the location management function network element, wherein the location information of the first apparatus is associated with the location information of the first tag and location information of the second tag.

7. The method according to claim 6, further comprising:
sending a second positioning request to the location management function network element, wherein the second positioning request requests to position the second tag, and wherein the second positioning request comprises an identifier of the second tag.

8. The method according to claim 1, wherein the at least one tag comprises a first tag, and wherein the obtaining location information of the at least one tag comprises:
receiving a first measurement result from the first access network device, wherein the first measurement result is obtained by the first access network device in a process of inventorying the first tag, and wherein the first measurement result is associated with location information of the first tag.

9. The method according to claim 8, wherein the first measurement result comprises at least one an identifier of a first cell, a first time difference, first phase information, or first angle information; and
wherein the first cell is a serving cell in which the first access network device provides a service for the first tag, wherein the first time difference is a time difference between time at which the first access network device sends a first message to the first tag and time at which the first access network device receives a second message from the first tag, wherein the first phase information indicates a carrier phase of a signal carrying the second message or indicates a carrier phase of a signal carrying the first message and a carrier phase of a signal carrying the second message, and wherein the first angle information indicates an angle of arrival of the signal carrying the second message.

10. The method according to claim 1, further comprising:
sending the location information of the at least one tag to an application function network element, or sending the location information of the first apparatus to an application function network element.

11. The method according to claim 1, wherein the at least one tag comprises a first tag; and
wherein the method further comprises:
sending a third message to the first tag, wherein the third message triggers the first tag to send a fourth message to the first access network device to measure a signal carrying the fourth message.

12. A positioning method, comprising:
receiving a first positioning request, wherein the first positioning request requests to position a first tag, and wherein the first positioning request comprises an identifier of the first tag;
sending a third positioning request to a first access network device, wherein the third positioning request requests to position the first tag, wherein the third positioning request comprises the identifier of the first tag, and wherein the first access network device provides a service for the first tag; and
receiving a second measurement result from the first access network device, wherein the second measurement result is associated with location information of the first tag.

13. The method according to claim 12, further comprising:
sending a fourth positioning request to a second access network device, wherein the fourth positioning request requests that the second access network device position the first tag, and wherein the fourth positioning request comprises the identifier of the first tag; and
receiving a third measurement result from the second access network device, wherein the third measurement result and the second measurement result are jointly associated with the location information of the first tag.

14. The method according to claim 12, wherein the first positioning request further comprises at least one of type information of the first tag or information about a service type of the first tag.

15. The method according to claim 12, wherein the third positioning request further comprises at least one of information about a positioning measurement manner, the type information of the first tag, or the information about the service type of the first tag.

16. The method according to claim 15, wherein the positioning measurement manner comprises angle measurement, phase measurement, signal strength measurement, multi-antenna measurement, fingerprint positioning measurement, or multi-tag assistance positioning measurement.

17. The method according to claim 12, further comprising:
sending the location information of the first tag to the tag management function network element.

18. The method according to claim 12, further comprising:
receiving a second positioning request, wherein the second positioning request requests to position a second tag, and wherein the second positioning request comprises an identifier of the second tag;
sending a fifth positioning request to the first access network device, wherein the fifth request requests to position the second tag, wherein the fifth positioning request comprises the identifier of the second tag, and wherein the first access network device further provides a service for the second tag; and
receiving a fourth measurement result from the first access network device, wherein the fourth measurement result is associated with location information of the second tag.

19. A communication apparatus, comprising:
a processor; and
at least one non-transitory computer readable memory connected to the processor and including computer program code, wherein the at least one non-transitory computer readable memory and the computer program code are configured, with the processor, to cause the apparatus to perform at least:
obtaining positioning information, wherein the positioning information comprises information about at least one tag;
sending a first inventory request to a first access network device, wherein the first inventory request requests to inventory the at least one tag, wherein the first inventory request comprises the information about the at least one tag, and wherein the first access network device provides a service for the at least one tag; and
obtaining location information of the at least one tag or a first apparatus on which the at least one tag is disposed.

20. The communication apparatus according to claim 19, wherein the at least one non-transitory computer readable memory and the computer program code are configured, with the processor, to further cause the apparatus to perform:
sending a first positioning request to a location management function network element, wherein the first positioning request requests to position the first tag, wherein and the first positioning request comprises an identifier of the first tag; and
wherein the obtaining location information of the at least one tag comprises:
receiving location information of the first tag from the location management function network element.
